(19) United States
(12) Patent Application Publication
(10) Pub. No.: US 2011/0293510 A1
(43) Pub. Date: Dec. 1, 2011

(54) AMMONIA FLAME CRACKER SYSTEM, METHOD AND APPARATUS

(76) Inventors: Shawn Grannell, Ann Arbor, MI (US); Donald E. Gillespie, Ann Arbor, MI (US)

(21) Appl. No.: 13/117,532

(22) Filed: May 27, 2011

Related U.S. Application Data
(60) Provisional application No. 61/348,898, filed on May 27, 2010.
(60) Provisional application No. 61/419,490, filed on Dec. 3, 2010.

(51) Int. Cl. C01B 3/04; B01J 19/00

(52) U.S. Cl. 423/658.2; 422/198

(57) ABSTRACT

Apparatus, methods and systems reside in the decomposition of ammonia into a hydrogen gas mixture. A premixed, ammonia-rich gaseous mixture of anhydrous ammonia and air enters into a conduit within which combustion and decomposition of a portion of the mixture is initiated, thereby liberating heat and hydrogen. The hydrogen mixes with the bulk of the gas mixture and the liberated heat drives the combustion reaction to completion, including portions of the gas not associated with the initial combustion and decomposition process. A mixture of gaseous products resulting from the reaction is expelled from the outlet of the conduit, the mixture including non-combusted hydrogen gas, which may then be used for other purposes. In the preferred embodiment, combustion and decomposition of a portion of the mixture is initiated with a heating element disposed within the conduit.

### REFERENCE TO RELATED APPLICATIONS

This application claims priority from U.S. Provisional Patent Application Ser. Nos. 61/348,898, filed May 27, 2010 and 61/419,490, filed Dec. 3, 2010, the entire content of both of which is incorporated herein by reference.

### FIELD OF THE INVENTION

The present disclosure relates to the operation of embodiments of an ammonia cracker capable of producing a hydrogen gas mixture from ammonia, and more particularly to the operation of an Ammonia Flame Cracker capable of decomposing ammonia into hydrogen and nitrogen, using heat derived from combusting a portion of the ammonia.

### BACKGROUND OF THE INVENTION

Due at least in part to high crude oil prices, environmental concerns, and future fuel availability, many internal combustion engine designers have looked to replace crude oil fossil fuels, e.g., gasoline and diesel, with so-called “alternative fuels” for powering internal combustions engines. Desirably, by replacing fossil fuels with alternative fuels, the cost of fueling internal combustion engines is decreased, harmful environmental pollutants are decreased, and/or the future availability of fuels is increased.

Ammonia is one such fuel capable of at least partially replacing crude oil based fossil fuels. Ammonia (NH₃) is widely used in household cleaning supplies and agricultural fertilizer. Unlike either gaseous hydrogen or natural gas, ammonia need not be stored under extreme pressures to maintain the ammonia at an energy density which is appropriate for use in propulsion applications such as automobiles and boats. Ammonia may be stored indefinitely as an anhydrous liquid at pressures nearly the same as those of propane, approximately 10 bars at 300 Kelvin. Ammonia has reasonable energy/volume and energy/mass densities, which, although lower as those of gasoline by factors of 2.6 and 2.3, respectively, are still well within reach of practical use in automobiles and other machinery as the principal energy carrier. Accordingly, ammonia may be transported via currently available high pressure pipelines. Ammonia may be made from energy sources, such as nuclear power, solar and wind, which are characterized as having a high density of energy production throughput per land surface area, and some of these energy sources have an energy throughput density that is more than 1000 times greater than the 2-3 kilowatts per hectare gross average liquid fuel production rate which is typical for the “biofuels”. Therefore, fuel manufacturing, handling, distribution, and use are more feasible for ammonia than for some of the other fuels.

The use of ammonia as an energy carrier makes possible the indirect use of energy obtained from nuclear fission or eventually fusion, in mobile applications where direct use would be impractical. In one example, high temperature nuclear reactor heat is used to drive a thermochemical cycle for generating hydrogen, and ammonia is made by combining the hydrogen with nitrogen, obtained by air separation. In another example, hydrogen is made by an electrolytic process, possibly at high temperatures, using nuclear power or renewable electricity and then ammonia is made by combining the hydrogen with nitrogen, obtained by air separation. The storage, distribution and use of energy obtained from stranded, remote, intermittently active, renewable sources such as wind, solar and others, or stranded natural gas which would otherwise be wasted, may also be addressed by using ammonia as an energy carrier.

Like electricity, ammonia is a value-added energy carrier which must be made, with attendant conversion losses, from primary energy. Also like electricity, ammonia is clean at the point of use, and it may also be made cleanly at the point of manufacture by appropriate choice of primary energy. In some applications, ammonia will be preferred over batteries as the principal means of energy storage, for example, in automobiles and in fishing vessels. Batteries can be prohibitively expensive and can weigh as much as, or much more, than the rest of the vehicle for an operating range which is currently typical for hydrocarbon fueled vehicles, for example automobiles which are expected to have a range of about 500 kilometers between refueling or recharging. Fishing vessels in the 10-20 tonne range may carry 3800 liters or more of diesel fuel, and for these, a rechargeable lithium ion battery, of the same effective energy storage capacity, would have a mass about 10 times greater than the boat. The plant-to-wheels efficiency of an energy chain consisting of, for example, a nuclear reactor, means for making electricity from reactor heat, an electric transmission grid, a battery charger, a battery with attendant charge/discharge losses, and an electric motor with controller (battery/electric) may be either only marginally better or perhaps worse, than an energy chain consisting of a nuclear reactor, means for making ammonia from reactor heat, and an ammonia-fueled internal combustion engine (ammonia/IC engine). Even for some cases in which the plant-to-wheels efficiency of battery/electric is substantially greater than that of ammonia/IC engine, ammonia/IC engine may still be preferred due to higher energy storage density and lower overall cost as compared to battery/electric.

The “yellow coal” limit is the lower bound on the concentration of a fissionable element in rock deemed feasible for mining, such that the mass of rock at the yellow coal limit which must be handled is equal to the mass of coal which must be handled for the same gross energy yield. The “yellow coal” term has been applied to uranium (yellow cake, hence yellow coal), and for the enriched uranium/once through fuel cycle the yellow coal limit is about 70 parts per million (ppm) by weight of natural uranium in rock. Calculations done for thorium fueled breeder reactors indicate a yellow coal limit of about 0.4 ppm by weight for thorium in rock, which is much lower than the estimated 6-12 ppm average concentration of thorium in the earth's crust. Hence the potentially recoverable reserves of primary energy, including thorium, which can be used to cleanly make both ammonia and electricity, are much, much greater than reserves of coal, oil and natural gas combined.

The inventors' previous U.S. Pat. No. 7,574,993 describes the use of ammonia with a combustion promoter to fuel an engine. In some cases the combustion promoter was another fuel stored separately from the ammonia. In other cases the combustion promoter was hydrogen. Desirably, the combustion promoter may be derived by using an ammonia cracker to decompose at least a portion of the ammonia into hydrogen and nitrogen, thus enabling engine operation with pure liquid anhydrous ammonia as the only stored fuel.

Ammonia crackers known to the art have difficulties and limitations because of large size and intricate design required for heat transfer, large quantities of sometimes expensive catalyst required to obtain a substantial ammonia decomposition yield, an uncontrolled and often low ammonia decomposition yield, and lack of rapid start capability. Ammonia crackers designed to use engine exhaust heat to decompose ammonia, such as the ammonia crackers disclosed in U.S. Pat. Nos. 2,140,254, 4,478,177, and 4,750,453, are often large, expensive, and intricate devices which must be placed in the engine exhaust flow. Furthermore, an engine's exhaust gas temperature is generally not high enough to decompose any of the ammonia without using an ammonia cracker catalyst. Such cracker catalysts may be large and expensive when sized for providing enough catalytic sites for catalytically decomposing ammonia at a high rate or high decomposition yield. In some instances, an engine's exhaust gas temperature may not be high enough to give acceptable ammonia cracker performance even with the use of a catalyst.

Ammonia crackers may be designed to use electricity to decompose ammonia at high temperatures, including temperatures at which ammonia will decompose rapidly and at a high decomposition yield without the aid of a catalyst (hereafter referred to as the “ammonia cracking temperature”). Examples include electrically heated ammonia crackers disclosed in U.S. Pat. Nos. 1,915,120, 2,264,693, 3,025,145, 3,379,507, and 3,598,538. For this discussion the class of electrically powered ammonia decomposers is broadened beyond ammonia crackers using resistively heated elements, to include ammonia decomposers which use electric arcs, electromagnetic energy such as microwaves, or electrolysis to decompose ammonia into hydrogen and nitrogen. However, the conversion of fuel energy into electricity, by an engine system, involves losses in the engine and losses in the generator. Electricity is thus, joule for joule, more costly to use for decomposing ammonia, than is heat obtained by combusting a portion of the ammonia. The Ammonia Flame Cracker (capitalized hereafter to distinguish the present invention from the prior art) embodiments disclosed herein are intended to obtain energy for decomposing ammonia principally from the combustion of some of the ammonia and not from electricity. Therefore, an engine system, incorporating one of the Ammonia Flame Cracker embodiments disclosed herein, will be somewhat more efficient than an otherwise similar engine system incorporating an electrically powered ammonia decomposer.

Even for non-engine applications, it may be preferred to obtain the heat required to decompose ammonia by combustion of a portion of the ammonia rather than by electrical heating because in some instances electricity may be more expensive than ammonia, and also because electrical heating may require an electrical hookup of very substantial capacity at the ammonia cracker whereas ammonia combustion does not. Furthermore, some applications may be remote. Other applications may be air-born, for example carried on board balloons, and for these applications the use of very substantial quantities electrical energy may be forbidden.

Hot filaments, for example glow plugs and the like, are known to the art and may be used for igniting ammonia within a combustion chamber of a piston engine. However, such a filament may prematurely ignite a homogeneous, premixed fuel/air charge, and a large pumping loss would occur if a piston engine were to include a provision for preventing contact between a premixed fuel/air charge and the filament during compression, and another provision for passing the entire charge through the filament region, within a short crank angle duration, when the piston is near top center. The implementation of these provisions within a combustion chamber of a piston engine or other engine with discrete firing cycles is also difficult, burdensome and expensive. Glow plugs are thus unsuitable for use in premixed charge engines with discrete firing cycles. Glow plugs which are used for igniting ammonia are not intended to substantially fully decompose an entire ammonia stream into a hydrogen-containing product mixture, which is destined for combustion or other use elsewhere. Glow plugs are also not generally controlled to operate at a particular ammonia/air equivalence ratio, and the filament in a glow plug may have a short service life because the adiabatic flame temperature is far in excess of the melting temperature of most common metals when the ammonia/air equivalence ratio is near stoichiometric, as is the case for combusting ammonia and other fuels with air in an engine.

“Normal air” (or simply “air”) is defined herein as the natural atmospheric mix of mostly nitrogen and oxygen, which is neither enriched nor depleted in oxygen content.

Ammonia burners, disclosed in U.S. Pat. No. 5,904,910, can combust ammonia with pure oxygen, or combust ammonia with other fuels and air, or combust ammonia with hydrogen obtained by earlier rich ammonia combustion with oxygen or with other fuels and air. However, the burners disclosed in U.S. Pat. No. 5,904,910 would not be operable to combust a very rich mixture of ammonia and normal air at an ammonia/air equivalence ratio which is richer than the upper flammability limit for ammonia in air, without first substantially raising the temperature of the mixture, and according to specifications, these burners achieve peak temperatures by first combusting the mixture. Some embodiments of the disclosed Ammonia Flame Cracker are operable to decompose ammonia in a single step, using ammonia and normal air as the only inputs, wherein the ammonia/air equivalence ratio is generally richer than the upper flammability limit for ammonia in air.

Ammonia crackers disclosed in U.S. Pat. Nos. 2,013,809, 2,601,221, 2,606,875, 6,007,699, and 6,800,386 operate by catalytically decomposing ammonia. Other ammonia crackers, such as those disclosed in U.S. Pat. Nos. 3,505,027, 4,069,071, 4,157,270, 4,179,407, 4,219,528, 5,055,282, 5,139,756, 5,976,723 and 6,800,386 operate at peak temperatures of 1100° C. or lower, at which non-catalyzed decomposition of ammonia will not occur at an appreciably high rate. Embodiments of the disclosed Ammonia Flame Cracker are operable to decompose ammonia at a high rate, at peak temperatures which are generally higher than 1100° C., and in a manner which is either substantially or fully non-catalytic.

Systems incorporating ammonia burners and cracker catalysts are disclosed in U.S. Pat. Nos. 4,788,004 and 6,936,363. These systems decompose ammonia on a catalyst, and then combust at least a portion of the decomposed ammonia or other fuels in a burner, which may or may not be catalytic, yielding heat which is used for decomposing more ammonia on the cracker catalyst. However, the systems, disclosed in U.S. Pat. Nos. 4,788,004 and 6,936,363, operate at peak temperatures of about 750° C., at which non-catalyzed decomposition of ammonia will not occur appreciably, thus the cracker catalyst must be sized for catalyzing all of the ammonia decomposition reactions. Some embodiments of the Ammonia Flame Cracker incorporate a catalyst, nevertheless these embodiments are intended to decompose ammonia at peak temperatures higher than 1100° C., at which most of the ammonia decomposes non-catalytically and at a high rate, thus the catalyst need be sized only for starting the reactions and not for catalyzing all of the reactions. Other embodiments of the disclosed Ammonia Flame Cracker are operable without the use of any catalyst. Operation of an Ammonia Flame Cracker without a catalyst is advantageous because some catalysts are expensive, and also because some catalysts may not be durable at temperatures at which ammonia rapidly decomposes non-catalytically.

Systems incorporating endothermic reaction loops heated by exothermic reaction loops are disclosed in U.S. Pat. No. 6,096,106. In basic structure, some of these are very similar to some embodiments of the Ammonia Flame Cracker, wherein ammonia or products of ammonia decomposition are combusted in a first exothermic loop and ammonia is decomposed in a second endothermic loop, and a heat exchange relationship exists between the first and second loops. However, the intent of the systems disclosed in U.S. Pat. No. 6,096,106 is the reformation of natural gas or other hydrocarbons, and not the decomposition of ammonia.

Based on the foregoing, there is a need for a rapid-starting device for decomposing ammonia into a hydrogen-containing product mixture, said device being characterized as compact and capable of decomposing ammonia at a high decomposition yield, at a high overall thermal conversion efficiency, and at a high throughput rate, using ammonia and normal air as the only inputs, and using very little or no catalyst.

### SUMMARY OF THE INVENTION

This invention broadly relates to the decomposition of ammonia into a hydrogen gas mixture. A method of cracking gaseous ammonia in accordance with the invention comprises flowing a premixed, ammonia-rich gaseous mixture of anhydrous ammonia and air into the inlet of a conduit. Combustion and decomposition of a portion of the mixture is initiated within the conduit, thereby liberating heat and hydrogen. The hydrogen mixes with the bulk of the gas mixture and the liberated heat drives the combustion reaction to completion, including portions of the gas not associated with the initial combustion and decomposition process. A mixture of gaseous products resulting from the reaction is expelled from the outlet of the conduit, the mixture including non-combusted hydrogen gas, which may then be used for other purposes.

In the preferred embodiment, combustion and decomposition of a portion of the mixture is initiated with a heating element disposed within the conduit. The initial combustion and decomposition results from a portion the gaseous mixture making contact with the heating element. The heating element may be a filament or set of filaments, one or more ribbons, a screen or set of screens, metal foam, or other geometry or combination of geometries. The heating element is constructed from one or more of the following elements: carbon, silicon, iron, cobalt, nickel, chromium, and a platinum-group metal. The dimensions and/or geometry of the heating element may be chosen so as to initiate flamelets of combustion on a sufficiently wide distribution of points that the respective flamelets traverse the burning gas mixture before it travels appreciably far from the region immediately adjacent the element.

The decomposition of the ammonia occurs substantially within the gaseous phase and at a temperature high enough for rapid and substantially non-catalyzed decomposition of the mixture in bulk. The mixture of gases from the outlet of the conduit may contain up to about one half hydrogen by volume. The hydrogen may be used as a combustion promoter after exiting the conduit and/or as fuel for an internal combustion engine, furnace or cooking appliance.

The ammonia/air mixture may have an equivalence ratio substantially above the normal rich flammability limit for ammonia in air. Materials in contact with the ammonia/air mixture in regions upstream of the element may be selected or treated so as to be substantially devoid of catalytic activity for either decomposing or combusting ammonia.

In accordance with a preferred embodiment, the heating element is an electrically powered resistive element. The heating element's electric power may be turned of or turned down to a nominal level during fully warmed up operation, and wherein the heat required to keep the heating element at the cracking temperature and to decompose ammonia is substantially derived from the combustion of some of the ammonia.

The temperature of the heating element may be monitored by measuring the resistance of the element or by measuring the thermal radiation of the element, with the electric power applied to the heating element being controlled to maintain at least a particular heating element temperature. The ammonia/air equivalence ratio may also be controlled as a function of measured temperature. At least a portion the sensible heat of the outbound hydrogen gas mixture may be recuperated into the incoming ammonia/air mixture through a counterflow heat exchange, thereby extending the range of equivalence ratios for which full ammonia decomposition yield is obtained, and improving the ammonia-to-hydrogen thermal conversion efficiency.

An ammonia flame cracker apparatus or system constructed in accordance with the invention includes a conduit having an inlet for receiving a premixed, ammonia-rich gaseous mixture of anhydrous ammonia and air. A heating element disposed within the conduit exhibits at least nominal catalytic activity sufficient to initiate combustion and decomposition of the mixture in contact with the element, thereby liberating sufficient heat and hydrogen to drive the combustion reaction to completion in portions of the mixture not in contact with the heating element. The outlet of the conduit expels a mixture of gases resulting from the reaction, the mixture preferably including excess non-combusted hydrogen gas.

### BRIEF DESCRIPTION OF THE DRAWINGS

FIG. 1 is a graph showing the basic features of a trajectory taken by ammonia or an ammonia-containing gas mixture during heat addition to the gas;

FIG. 2 is a graph showing the equivalence ratio at which the ammonia combustion and ammonia decomposition give zero temperature rise when the reactions are run to completion;

FIG. 3 is a graph showing a representative performance curve of a heat exchanged Ammonia Flame Cracker among curves from a theoretical model;

FIG. 4 is a schematic diagram of an Ammonia Flame Cracker according to one representative embodiment;

FIG. 5 is a schematic diagram of a heat exchanged Ammonia Flame Cracker according to one representative embodiment;

FIG. 6 is a schematic diagram of an Ammonia Flame Cracker with separate ammonia combustion and ammonia decomposition loops, and fuel cell system incorporating the same, according to one representative embodiment; and

FIG. 7 is a graph showing the adiabatic flame temperature for different mixtures of ammonia and oxidizers which may be used during ammonia cracker startup.

### DETAILED DESCRIPTION OF THE PREFERRED EMBODIMENTS

Described herein are apparatus, systems and methods for decomposing ammonia into a hydrogen-containing product mixture. The invention is compact and capable of decomposing ammonia at a high decomposition yield, at a high overall thermal conversion efficiency, and at a high throughput rate, using ammonia and normal air as the only inputs, and using very little or no catalyst. A rich mixture of ammonia and air undergoes an avalanche of water formation and ammonia decomposition reactions when a temperature is reached, at which ammonia decomposes non-catalytically. The decomposition of ammonia thus occurs substantially within the gas phase, and in some cases, without the aid of any catalyst.

A heat exchanger permits the use of reaction temperatures in excess of 1100° C. without an energy penalty because most of the sensible heat in the outgoing product mixture can be recuperated into the incoming reactant mixture, and in some cases, this heat recuperation causes the mixture to react. The resulting hydrogen gas mixture may contain up to about one half hydrogen by volume and may be used to fuel an engine for which ammonia is the only stored fuel, to fuel a burner such as in a furnace or in an outdoor cooking appliance, for various applications requiring the use of a hydrogen/nitrogen “form gas” mixture, or the hydrogen may be purified by means known to the art for use in other applications, such as a lift gas for a balloon.

In one embodiment, combustion of a premixed ammonia-rich ammonia and air mixture is initiated on a reactive element of materials chosen for at least nominal catalytic activity, for withstanding the peak temperature and chemical environment, and, in some instances, for appropriate electrical resistivity. The reactive element may be a filament or set of filaments, one or more ribbons, a screen or set of screens, metal foam, a coating, or some other geometry or combination of geometries, but hereafter the reactive element will be referred to as a “catalyst”. Examples of functional catalyst materials include, but are not limited to: nichrome, nichrome coated with nickel, nickel, stainless steel and nichrome coated with platinum.

It was found that catalysts of pure nickel and nichrome corrode at an appreciable rate during operation of an Ammonia Flame Cracker. These and other metals of a similar melting temperature near 1400° C. are marginally above the ammonia cracking temperature. Other alloys with greater corrosion resistance and melting temperatures of 1500° C. or higher may be used as catalysts toward the advantage of increased durability and for a wide margin between the ammonia cracking temperature and catalyst melting temperature. Examples of such catalyst materials may include, but are not limited to, alloys of chromium and platinum-group metals, or chromium with a platinum-group metal coating, or a doped semiconductor and/or ceramic such as silicon carbide, coated with a very small quantity of a platinum-group metal. Some Ammonia Flame Cracker embodiments incorporating catalysts may be heat exchanged toward the advantage of obtaining a full ammonia decomposition yield at a higher range of ammonia/air equivalence ratios.

In some embodiments a continuously flowing ammonia-rich ammonia/air mixture is brought up to the ammonia cracking temperature in a heat exchanger. A relatively small amount of hydrogen is produced within the mixture when the ammonia begins to decompose. The hydrogen then autoignites, and the mixture combusts and at least a portion of the ammonia decomposes without the use of any catalysts, thus the cracking can be initiated and completed fully non-catalytically. The heat exchanger then transfers at least a portion of the outgoing hydrogen-containing product mixture's sensible heat into the incoming ammonia/air mixture. The heat released by the formation of water maintains at least a portion of the heat exchanger at temperatures equaling or exceeding the ammonia cracking temperature, and the heat released by the formation of water is used to decompose at least a portion of the ammonia into hydrogen and nitrogen. Ammonia Flame Cracker embodiments which are functional without a catalyst are advantageous because catalyst cost is omitted, catalyst durability may otherwise be a problem at the ammonia cracking temperature, and also the engineering requirements for catalyst placement are relaxed. Even “platinum-group” metals, which include ruthenium, rhodium, palladium, osmium, iridium and platinum, may slowly corrode, evaporate, sinter or otherwise degrade at the ammonia cracking temperature.

In some embodiments a continuously flowing, premixed lean or stoichiometric ammonia/air mixture is combusted within a first exothermic loop of a heat exchanger, and ammonia is at least partially decomposed into hydrogen and nitrogen within a second endothermic loop of the same heat exchanger. The ammonia/air mixture entering the first loop is brought up to the ammonia cracking temperature, at which point it combusts and releases heat without the aid of a catalyst. The ammonia entering the second loop is raised to the ammonia cracking temperature and the ammonia is at least partially decomposed into hydrogen and nitrogen. Then the outgoing combusted products in the first loop and outgoing cracked mixture in the second loop are heat exchanged with the incoming ammonia/air mixture in the first loop and incoming ammonia in the second loop. The combusted products exiting from the first loop may then be discarded or used elsewhere. These embodiments may be operated toward the advantage of obtaining a hydrogen gas mixture which is devoid of water and also of reduced nitrogen content.

In some embodiments a fuel gas is combusted with air within a first exothermic loop of a heat exchanger, and ammonia is at least partially decomposed into hydrogen and nitrogen within a second endothermic loop of the same heat exchanger. The fuel gas and air enter the first loop and are preheated separately until they reach a combustion zone, at which point the fuel gas and air mix and combust. The fuel gas/air mixing may be done in a distributed way, such that combustion and heat exchange processes are spread out, thus lowering peak surface temperatures as required to maintain the heat exchanger materials within the durability limit. The fuel gas and air are kept separate until reaching a combustion zone because in some instances, for example a fuel gas containing hydrogen, a premixed fuel gas/air mixture will autoignite at some temperature which is substantially lower than the ammonia cracking temperature, thus releasing a portion of heat through a temperature range which is lower than the ammonia cracking temperature, which would lower the overall efficiency of the ammonia cracker.

Even when the fuel gas is ammonia, it may be advantageous to keep the fuel gas and air separate and then combine them in a distributed combustion zone, because the distribution of combustion gives positive control of the exact location and distribution of the heat released by combustion. The fuel gas and air may be preheated to temperatures exceeding the ammonia cracking temperature prior to mixing and combustion. The ammonia entering the second loop is raised to the ammonia cracking temperature and the ammonia is at least partially decomposed into hydrogen and nitrogen. Then the outgoing combusted products in the first loop and outgoing cracked mixture in the second loop are heat exchanged with the incoming separate fuel gas and air in the first loop and incoming ammonia in the second loop. The combusted products exiting from the first loop are discarded or used elsewhere, and the hydrogen-containing gas mixture exiting from the second loop is used for any of the various applications disclosed herein. These embodiments may also be operated toward the advantage of obtaining a hydrogen gas mixture which is devoid of water and also of reduced nitrogen content. Furthermore, these embodiments may be used to operate a fuel cell. The hydrogen gas mixture exiting from the second loop flows through the fuel cell, wherein hydrogen is consumed and the hydrogen gas mixture becomes depleted of hydrogen content. The depleted hydrogen gas mixture is purged from the fuel cell, and any hydrogen or other fuel left over in the depleted mixture is combusted in the first loop of the heat exchanger. Total gas flow and hydrogen consumption by the fuel cell may be controlled such that the chemical energy content of the depleted hydrogen gas mixture entering the first exothermic loop of the heat exchanger is sufficient to fully decompose the ammonia entering the second endothermic loop of the heat exchanger.

Embodiments of the Ammonia Flame Cracker may be started by electrical resistive heating of the catalyst and/or portions of the heat exchanger. In some instances, the quantity of electrical energy involved in starting an Ammonia Flame Cracker may be large, or a long startup delay may be involved when electricity is used to start an Ammonia Flame Cracker.

Embodiments of the Ammonia Flame Cracker may be started by combusting a near-stoichiometric mixture of ammonia and air to supply the heat required for quickly bringing portions of the Ammonia Flame Cracker up to operating temperature. The ammonia/air mixture does not normally support flame propagation under ordinary conditions, but it can be ignited continuously by passage through an electric arc of sufficient intensity and distribution. The ammonia/air mixture thus acts as an energy multiplier which reduces the electrical energy requirement for starting the Ammonia Flame Cracker. It was observed that an energy multiplication factor of at least 3 can readily be obtained by passing a near-stoichiometric ammonia/air mixture through a rotating electric arc. Very high multiplication factors of at least 10 can be obtained by passing a rich ammonia/air mixture over a catalyst. The mixture combusts and decomposes, and additional air can be introduced downstream of the catalyst to burn the leftover hydrogen for additional heat. Electrical energy is required only to bring the catalyst up to a catalytic light off temperature. The “catalytic light-off temperature” is the minimum temperature at which a given catalyst will display substantial activity for catalytically combusting or decomposing ammonia. Additional electric power may be supplied to portions of the catalyst at nominal power levels to ensure the stability of the catalyst's temperature and catalytic activity profile. Heat, which is released by both the ammonia/air combustion and the electric power, is distributed to the Ammonia Flame Cracker by flowing of the hot combusted mixture over surfaces within the Ammonia Flame Cracker, preferably beginning with the surfaces of highest operating temperature.

Embodiments of the Ammonia Flame Cracker may be started by combustion of a starter fuel, other than ammonia, to supply the heat required for quickly bringing portions of the Ammonia Flame Cracker up to operating temperature. Heat, which is released by combustion of the starter fuel, is distributed to the Ammonia Flame Cracker by flowing of the hot combusted mixture over surfaces within the Ammonia Flame Cracker, preferably beginning with the surfaces of highest operating temperature. Examples of starter fuels may include a hydrogen gas mixture which was obtained and stored during previous operation of the Ammonia Flame Cracker, or other fuels such as propane which are stored separately from the ammonia. At startup, an engine or other combustion apparatus may be started and run immediately on the starter fuel until the Ammonia Flame Cracker becomes operational, at which point the engine or other combustion apparatus ceases use of the starter fuel and begins use of the Ammonia Flame Cracker output. However, the use of other fuels such as propane at startup, although feasible, negates the intent of using ammonia as the only fuel. To the extent that flammability limits permit, the starter fuel may be used with a portion of ammonia for both running the engine and for heating the Ammonia Flame Cracker, thus reducing the quantity of starter fuel consumed during startup. The use of the hydrogen gas mixture as a starter fuel can be problematic in a “dead start” condition, wherein the starter fuel is exhausted, because the hydrogen gas mixture can only be replenished after the Ammonia Flame Cracker becomes operational. Revival from a dead start condition thus requires replenishment of the hydrogen from a source other than the Ammonia Flame Cracker.

Embodiments of the Ammonia Flame Cracker may be started by combusting a substantially rich mixture of ammonia and a substantially pure oxidizer to supply the heat required for quickly bringing portions of the Ammonia Flame Cracker up to operating temperature. Examples of such oxidizers include molecular oxygen, nitrogen dioxide, nitric oxide, nitrous oxide, and hydrogen peroxide. Oxygen can be stored as a high pressure gas or it can be obtained by extraction from air, using one of many air separators known to the art. Nitrogen dioxide, nitrous oxide and hydrogen peroxide can readily be stored as liquids in quantities sufficient for hundreds of starts. Nitrous oxide is relatively nontoxic, and has a low freezing point.

At 25° C., a rich ammonia/oxygen mixture supports flame propagation and it has an adiabatic flame temperature exceeding the ammonia cracking temperature when the ammonia/oxygen equivalence ratio is less than about 2.4-2.9. Even without preheating, the ammonia/oxygen mixture is flammable, and it makes a combustible hydrogen gas mixture when it reacts. Heat, which is released by the ammonia/oxygen combustion, is distributed to the Ammonia Flame Cracker by flowing the hot combusted mixture over surfaces within the Ammonia Flame Cracker, preferably beginning with the surfaces of highest operating temperature. A portion of the heat released by combustion of the ammonia/oxygen mixture also goes into non-catalytically decomposing at least a portion of the excess ammonia into hydrogen and nitrogen. The combusted mixture thus contains a substantial hydrogen fraction and it may be used to run an engine or other combustion apparatus. The use of oxygen or other pure oxidizers thus permits instant starting and running of an engine or other combustion apparatus while the Ammonia Flame Cracker is warming up, without using fuels other than ammonia. At startup, an engine or other combustion apparatus may be started and run immediately on the hydrogen gas mixture produced by the combustion of the rich ammonia/oxidizer mixture until the Ammonia Flame Cracker reaches an operational state, at which time the oxidizer flow ceases and the Ammonia Flame Cracker begins to use air for producing the hydrogen gas mixture from ammonia. Oxygen can be stored in a high pressure bottle in quantities sufficient for many starts, or it can stored in smaller quantities sufficient for one or several starts, and then replenished after starting by use of means known to the art for extracting oxygen from air, for example, a pressure swing adsorption unit. Substantially pure oxygen is not used during normal operation of the Ammonia Flame Cracker, thus the oxygen extractor needs only to be designed for replenishing a starting charge within a reasonable running time, for example, a minute. Revival from a dead start condition, wherein the supply of oxygen is exhausted, can be effected by operating the oxygen extractor to replenish the starter oxygen before making a starting attempt. The “jump starting” of an ammonia-fueled vehicle with a dead battery and an exhausted oxygen supply thus requires only the usual electrical connection that a gasoline fueled vehicle with a dead battery would also require.

In some embodiments of the Ammonia Flame Cracker, at least a portion of the oxygen in an oxygen-containing gas and a portion of the ammonia are combusted, and at least a substantial portion of the remaining ammonia is decomposed into hydrogen and nitrogen. Typically, the oxygen-containing gas is normal air which is neither enriched nor depleted in oxygen content. The disclosed embodiments of the Ammonia Flame Cracker are thus generally operable with ammonia and air as the only inputs, and without the use of air separating equipment, although the use of substantially pure oxygen can be usefully incorporated into an Ammonia Flame Cracker's startup strategy. The total ammonia/air reaction is described by the following equation:

0.79N₂+0.21O₂+0.28φNH₃→0.42H₂O+(0.93+0.14(φ−1)X)N₂+0.42×(φ−1)H₂+0.28(φ−1)(1−X)NH₃
φ=ammonia/air equivalence ratio, and φ>1
X=decomposition yield of the uncombusted ammonia portion, and 0≦x≦1

The resulting gas mixture containing hydrogen can be used to fuel an engine for which ammonia is the only stored fuel, to fuel a burner such as in a furnace or in a cooking appliance, or for various applications requiring the use of a hydrogen/nitrogen “form gas” mixture. The disclosed Ammonia Flame Cracker also enables the use of ammonia as a hydrogen distribution medium. Hydrogen can be made into ammonia at a hydrogen production site. The hydrogen can then be stored and distributed as ammonia, and when desired, an Ammonia Flame Cracker can be used to reconstitute the hydrogen, in some cases at a high purity level by gas separation means known to the art.

An Ammonia Flame Cracker can also be incorporated into a device for providing a hydrogen lift gas for a balloon. Ammonia has high hydrogen content and in some cases it is simpler and less expensive to obtain hydrogen by decomposing ammonia, which can be done non-catalytically and in a single step, than to obtain hydrogen by reforming alcohols or hydrocarbons.

One embodiment of this invention uses a catalyst of at least nominal catalytic activity to initiate the combustion and decomposition of a rich, premixed, continuously flowing ammonia/air mixture. The ammonia/air mixture is usually of an equivalence ratio that is well above the normal rich flammability limit for ammonia in air. The ammonia combustion and decomposition reactions occurring on the catalyst's surface release heat and hydrogen, and this initial release permits flame propagation into portions of the gas which are not in contact with the catalyst. The ammonia combustion reaction is thus initiated on the catalyst's surface, but occurs substantially within the bulk gas. Catalysts thus serve to initiate reactions in ammonia/air mixtures which start the reaction sequence at an initial temperature which is lower than the ammonia cracking temperature. Combinations of mixture temperature in the catalyst inlet region and equivalence ratio may be chosen such that the adiabatic flame temperature equals or exceeds the ammonia cracking temperature. When the adiabatic flame temperature equals or exceeds the ammonia cracking temperature, the ammonia decomposition reaction occurs substantially within the flame, and the ammonia decomposition reaction does not depend on substantial contributions of catalytic activity. The catalyst thus needs not to be sized for providing enough catalytic sites for full decomposition of the ammonia on the surface of the catalyst. Instead, the catalyst is sized to provide a sufficient distribution of flame (flamelet) initiation points, and to provide sufficient initial hydrogen yield, such that the respective flamelets traverse the burning gas mixture before it flows appreciably far from the catalyst region. The ammonia combustion and decomposition reactions thus occur within and slightly downstream of the catalyst region.

Any possibly hot materials in contact with the ammonia/air mixture in regions upstream of the catalyst may be chosen to be substantially devoid of catalytic activity for either decomposing or combusting ammonia. In some instances the ammonia/air mixture may be preheated before coming into contact with the catalyst, and for these instances an absence of catalytic activity in possibly heated regions, upstream of the catalyst, ensures that a maximum heat transfer into the ammonia/air mixture can be obtained before any reactions begin. Once started, the reactions proceed without additional heat input. In some instances Ammonia Flame Crackers, which use a catalyst to initiate the reactions, may be operable without a provision for preheating the ammonia/air mixture.

In some instances, when the Ammonia Flame Cracker is started, the catalyst or other heater may be resistively heated by the application of electric power through wires. Other means of heating the catalyst are possible, including inductive heating, brief combustion of chemicals on the catalyst and/or surrounding structure, or an electric arc. Resistive heating of the catalyst may be used to start the ammonia combustion and decomposition reactions and to provide makeup heat to the burning gases, as required until the Ammonia Flame Cracker is fully warmed up. In some instances, the Ammonia Flame Cracker may be brought to a substantially fully warmed up state at startup by application of electric power to the catalyst or other heater and possibly also to other portions of the Ammonia Flame Cracker, immediately before mixture flow begins. In some instances, after the Ammonia Flame Cracker is started, the electric power applied to the catalyst or other heater may be turned off. In some instances, the electric power applied to the catalyst or other heater may be turned down and maintained at a nominal, possibly variable level for the purpose of fine control, such that the energy required to decompose ammonia is substantially provided by the combustion of some of the ammonia, and the ammonia combustion reaction is substantially sufficient to keep the catalyst hot. In some instances, the temperature of the ammonia/air mixture immediately upstream of the catalyst may be monitored, and the equivalence ratio and/or electric power applied to the catalyst or other heater may be controlled according to this temperature such that a particular chosen ammonia decomposition yield may be achieved, for example, substantially full decomposition of all ammonia not consumed in the ammonia combustion reaction.

Some embodiments use a heat exchanger to bring an ammonia/air mixture up to the ammonia cracking temperature, thereby initiating the ammonia combustion and decomposition reactions without the use of a catalyst. Ammonia crackers which are operable without catalysts are useful because some catalytic metals are expensive, and also because catalyst-free operation solves the problems concerning catalyst placement, and the durability of metals and metal catalysts at the ammonia cracking temperature. Even some platinum-group metals may be subject to slow oxidation, evaporation, sintering or other degradation at the ammonia cracking temperature. The ammonia/air mixture autoignites at the ammonia cracking temperature, and heat is yielded which may decompose additional ammonia in the mixture. Ammonia combustion and ammonia decomposition may also occur in separate loops if it is desired to exclude all of the water and some of the nitrogen that would otherwise be present in the hydrogen-containing product mixture. The heat released by ammonia combustion also maintains portions of the heat exchanger at temperatures which equal or exceed the ammonia cracking temperature. Ammonia crackers, which bring rich ammonia/air mixtures up to the cracking temperature through a heat exchange process and thereby ignite the mixture, are operable to decompose ammonia and produce a hydrogen gas mixture from normal air and ammonia as the only inputs, without the need for catalysts or for other combustible materials besides normal air and ammonia.

The hydrogen gas mixture produced by the Ammonia Flame Cracker may be used as the combustion promoter according to a combustion promoter/ammonia dual fuel map described in a previous U.S. Pat. No. 7,574,993, the entire content of which is incorporated herein by reference. The specification for using a constant quantity of combustion promoter per firing cycle, for a given engine RPM (revolutions per minute crankshaft speed), is the simplest, reasonably accurate description of a necessary and sufficient condition required for burning ammonia in an engine. One advantage, derived from using an Ammonia Flame Cracker to produce a hydrogen gas mixture for use as the combustion promoter, is that the decomposition yield can be well controlled and thus the ammonia/hydrogen ratio can more easily be made to comply with a predetermined operating map, for example, a rough limit, than would be possible if an exhaust heat ammonia cracker were used.

For operation according to a combustion promoter/ammonia dual fuel map, some of the ammonia used by the engine is run through the Ammonia Flame Cracker and the Ammonia Flame Cracker may be controlled to give a substantially full ammonia decomposition yield, and some of the ammonia bypasses the cracker. A substantially full ammonia decomposition yield, in the Ammonia Flame Cracker, makes it possible to tightly control the ammonia/hydrogen ratio in the intake mixture, by varying the ratio of ammonia bypassing the Ammonia Flame Cracker to that which is run through the Ammonia Flame Cracker. Operation, at the rough limit on ammonia and the hydrogen gas mixture, minimizes the engineering requirements of the Ammonia Flame Cracker, for example, size, cost, energy consumption, required flow capacity, and quantity of materials used in the construction of the Ammonia Flame Cracker.

Alternatively, an engine can be fueled solely by the hydrogen-containing product mixture produced by an Ammonia Flame Cracker. An engine or other combustion apparatus can be run solely on the hydrogen-containing product mixture, toward the advantage that the exhaust emissions of ammonia and nitrous oxide can be made very small or zero. Thus engines, which may not use sophisticated emissions controls due to cost, space, weight or simplicity constraints, may use ammonia as the sole fuel without emission of large amounts of ammonia or nitrous oxide in the exhaust when all of the ammonia used by the engine system is run through an Ammonia Flame Cracker and the Ammonia Flame Cracker is controlled to give a substantially full ammonia decomposition yield.

Some embodiments of the Ammonia Flame Cracker produce a hydrogen-containing product mixture with a hydrogen/inert ratio of approximately 1:1 by volume. The extra inert nitrogen and water from the ammonia/air combustion has the effect of reducing NO emissions when the hydrogen-containing product mixture is burned and also enables an engine to run solely on the hydrogen-containing product mixture at significantly higher loads and compression ratios without knock and backfire, than would be possible for operation on the 3:1 hydrogen/nitrogen mixture obtained by simply decomposing ammonia.

The entire hydrogen-containing product mixture can be metered into the engine in gaseous form. Alternatively, cooling may be used to lower the temperature of the hydrogen-containing product mixture and condense a substantial portion of the water which may be present in the mixture. This liquid water may be discarded without metering it into the engine, or a portion of the water may be discarded and the remainder may be metered into the engine, or all of the liquid water may be drafted into the engine along with the gaseous hydrogen and nitrogen portions. This liquid water can be used as an antiknock agent, thus permitting substantially supercharged engine operation on the hydrogen mixture. The liquid water vaporizes during compression, thus lowering the temperature of portions of gas yet to be burned. Knock is prevented when the temperature, of portions of gas yet to be burned, remains below the autoignition temperature of hydrogen at peak pressure. The extraction of liquid water from the hydrogen-containing product mixture permits the use of liquid water as an antiknock agent for a hydrogen fueled engine without separately storing water, and without separating water from the exhaust.

The engine may have a compression ratio which is chosen to be sufficiently high, such that the residual gas temperature at the end of the exhaust stroke is low enough to avoid autoigniting the intake mixture at the start of an intake stroke, thereby avoiding backfire. A portion of condensed water obtained from the hydrogen-containing product mixture may be fogged into the engine along with the intake mixture, sufficient to avoid knock at compression ratios which are high enough to avoid backfire. The quantity of liquid water fogged or otherwise metered into the engine, may be chosen such that the water is substantially fully vaporized before substantial combustion of the fuel begins. Any water not fully vaporized upon combustion of the fuel has its heat of vaporization effectively subtracted from the heat released by fuel combustion, thereby lowering the work yield and efficiency, and causing the engine to behave sluggishly. Preferably, no more liquid water should be metered into the engine intake than can be fully vaporized during an interval beginning at the start of compression and ending at the spark or other ignition event.

Notably, an engine which is normally run according to a dual fuel operating map, for example, a rough limit map as described in U.S. Pat. No. 7,574,993, may be run solely on the hydrogen gas mixture during warm-up and/or until exhaust catalytic converter light-off to minimize or eliminate the emission of ammonia in the exhaust, or to ensure a low COV(IMEP) during engine warm-up.

According to one representative embodiment, when combustion is initiated in a rich ammonia/air mixture by a catalyst of at least nominal catalytic activity, a full or partial ammonia decomposition yield may occur. The catalyst maintains a stable profile of temperature and catalytic activity, even with the electric power turned off, for combinations of gas temperature at the catalyst inlet, and equivalence ratio, for which the heat released by the ammonia combustion is at least sufficient, to raise the mixture temperature from a given catalyst inlet temperature to the ammonia cracking temperature, and also to decompose at least some of the remaining ammonia. If the gas temperature at the catalyst inlet region is higher than or equal to the catalyst light-off temperature, then stable operation is assured. The catalyst's steady state behavior may be described as being like a continually operating, unpowered igniter which ignites the ammonia/air mixture in many points as the mixture passes over the catalyst.

Stable operation may also occur even when the gas temperature at the catalyst inlet is lower than the catalyst light-off temperature. If the equivalence ratio is chosen such that the quantity of heat, released by the exothermic formation of water, is sufficient to bring the mixture up to the ammonia cracking temperature and decompose all of the ammonia, and if enough heat can radiate or conduct backward through the catalyst region to keep the upstream portions of the catalyst hot, then stable operation can be achieved. Experiments verified that when the catalyst inlet temperature is about 25° C., the catalyst maintains a stable temperature and catalytic activity profile with the electric power turned off, when the ammonia/air equivalence ratio is less than about 2. This result is consistent with theoretical calculations.

In some instances, the Ammonia Flame Cracker may have a catalyst inlet temperature which is elevated substantially above the ambient temperature, such as in the compressed zone of a turbine, or for cases in which the ammonia/air mixture is preheated by one or more components of the Ammonia Flame Cracker before the mixture reaches the catalyst. Elevated catalyst inlet temperatures permit obtaining full ammonia decomposition yield at higher range of ammonia/air equivalence ratios.

If the ammonia/air mixture is preheated with just enough heat to bring the mixture temperature up to the temperature at which ammonia begins to decompose spontaneously at a high rate without the aid of a catalyst, then all of the heat released by the ammonia combustion reaction may be utilized by the ammonia decomposition reaction. An equivalence ratio may be chosen such that, when the ammonia combustion and decomposition reactions are run to completion, then the heat released by the formation of water equals the heat absorbed by the decomposition of ammonia, and the mixture undergoes zero temperature change when it reacts. This limiting theoretical case assumes zero heat loss and the use of a perfect counterflow heat exchanger to preheat the incoming ammonia/air mixture, using heat extracted from the outbound hydrogen-containing product mixture. The placement, of ammonia combustion and ammonia decomposition processes into separate loops, does not alter the theoretical limits of efficiency and yield. In practice, an Ammonia Flame Cracker can be operated at a high efficiency for converting ammonia into hydrogen in some instances, and for converting ammonia into a combination of hydrogen and sensible heat in other instances.

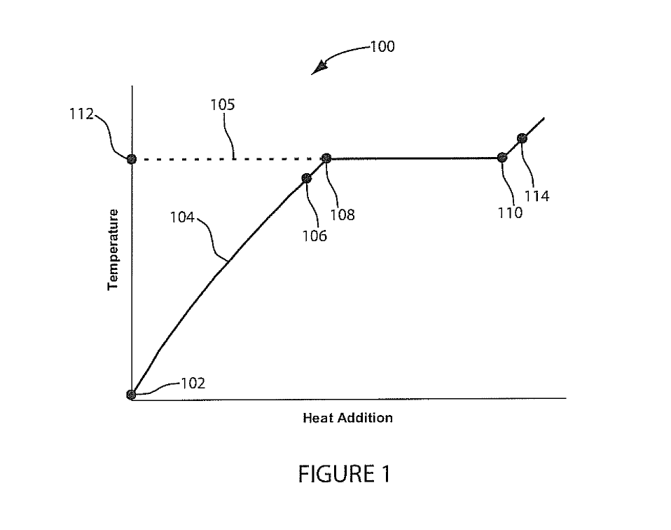

FIG. 1 shows a graph 100 of a trajectory 104 taken by ammonia, or a gas mixture containing ammonia, as heat is added to the gas at constant pressure. The “Temperature” and “Heat Addition” axes are labeled in unspecified units because graph 100 is intended to show basic features, the characteristics of which don't depend appreciably on particular values. Also, the actual quantities of heat added per mass of ammonia, through a given temperature range, will depend on unspecified parameters such as inert gases and other gases which may be mixed with the ammonia. Ammonia decomposition is modeled like a one-way phase transition. The ammonia decomposes irreversibly into hydrogen and nitrogen. In the absence of a catalyst, ammonia decomposes at a decomposition rate which is assumed to be zero for temperatures below the ammonia cracking temperature 112, and infinite for temperatures above the ammonia cracking temperature 112.

Various points 102, 106, 108, 110, and 114 on trajectory 104 are labeled in graph 100. Dashed line 105 shows that points 108 and 110, and also the portion of trajectory 104 between points 108 and 110, are directly across from the ammonia cracking temperature 112. The initial point 102 corresponds to a fresh ammonia-containing gas mixture at 25° C. For convenience, ambient temperature is assumed to be 25° C. for calculation of various curves, and the Heat Addition is set equal to zero at 25° C. for point 102. The actual ambient temperature may be substantially higher or lower than 25° C., nevertheless the qualitative characteristics of features described will remain the same. In departure upward and toward the right from point 102, the temperature of the ammonia-containing gas mixture goes up as heat is added, and in the absence of a catalyst, very little or none of the ammonia decomposes during movement on the portion of trajectory 104 between points 102 and 108. The ammonia cracking temperature 112 is reached at point 108. At point 108, further heat addition results in the endothermic decomposition of the ammonia into hydrogen and nitrogen. Ammonia decomposition occurs at the ammonia cracking temperature 112 within the portion of trajectory 104 between points 108 and 110, wherein very little or none of the ammonia is decomposed at 108, and substantially all of the ammonia is decomposed at 110. Further heat addition, into the gas mixture beyond point 110, causes the gas temperature to become increasingly higher than the ammonia cracking temperature 112.

Heat addition can occur by external application of heat to the gas mixture by a heat exchange process. Heat addition can also occur from within the gas mixture by breaking and forming chemical bonds other than those involved in the decomposition of ammonia into hydrogen and nitrogen. For example, if the ammonia-containing gas mixture also contains molecular oxygen, then the exothermic formation of water may be one of the sources of added heat which moves the gas mixture through portions of trajectory 104.

In an idealized example, a rich mixture of ammonia and normal air, which is richer than the upper flammability limit of ammonia in normal air, is heated from an ambient temperature of about 25° C. to the ammonia cracking temperature 112, thereby moving the gas mixture upward through the portion of trajectory 104 between points 102 and 108. In the absence of a catalyst, the rich ammonia/air mixture remains chemically inert during movement from point 102 to point 108, because the ammonia does not appreciably decompose. Water also cannot form in the rich ammonia/air mixture until the ammonia begins to decompose, because molecular hydrogen becomes freely available to react with oxygen only when ammonia decomposes. The exothermic formation of substantial quantities of water, and attendant release of heat, is thus locked out until the ammonia/air mixture either reaches the ammonia cracking temperature 112, or encounters a catalyst, and some embodiments of the Ammonia Flame Cracker are designed to take advantage of this lock-out effect.

When point 108 is reached, a small quantity of ammonia decomposes, releasing hydrogen, and this hydrogen quickly reacts with available oxygen at the ammonia cracking temperature 112, forming water and releasing heat, thus decomposing more ammonia. A growing avalanche of water formation and ammonia decomposition is thus initiated at the ammonia cracking temperature 112, and the formation of water continues until all of the molecular oxygen is consumed. The heat, released by the formation of water, moves the gas mixture along trajectory 104 from point 108 toward point 110. The excursion from point 108 to point 110 occurs at the ammonia cracking temperature 112. If the mixture runs out of oxygen before all of the ammonia is decomposed, then the state of the mixture at the end of its excursion on trajectory 104 will correspond to a point somewhere between points 108 and 110 on trajectory 104, and the temperature will be the ammonia cracking temperature 112. If all of the ammonia is decomposed before the mixture runs out of oxygen, then the state of the mixture at the end of its excursion on trajectory 104 will correspond to a point somewhere above and to the right of point 110 on trajectory 104, and the temperature will be higher than the ammonia cracking temperature 112.

In the idealized example, an ammonia/air equivalence ratio is chosen such that the quantity of heat, released by the formation of water, is just sufficient to move the gas mixture from point 108 to point 110, thus decomposing all of the ammonia, when all of the molecular oxygen is consumed. Upon reaching point 110, the reacted product gas mixture is then heat exchanged with an equal mass of fresh incoming ammonia/air reactant mixture. If an ideal, counterflow heat exchanger is used, then the next incoming mass of ammonia/air mixture can be heated from point 102 to point 108 on trajectory 104, and the chemical reactions begin anew. This process can be run under continuous flow.

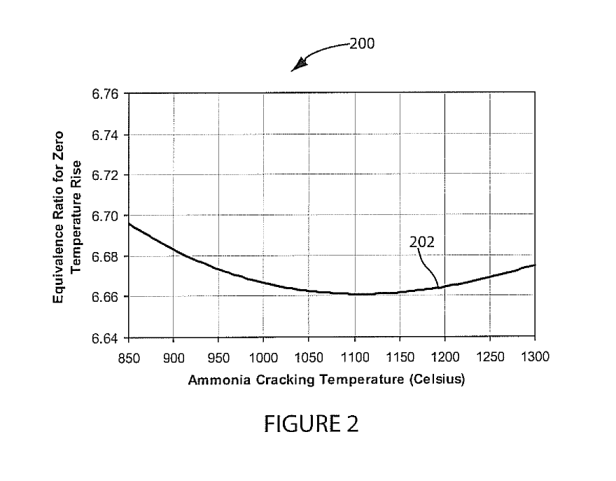

FIG. 2 shows a graph 200 of a curve 202 which is used for calculating a theoretical upper performance limit of an Ammonia Flame Cracker incorporating an ideal counterflow heat exchanger, according to the idealized example described in the discussion of FIG. 1. Curve 202 shows ammonia/air equivalence ratios for which the quantity of heat, released by the exothermic formation of water, is just sufficient to move the gas mixture from point 108 to point 110 on trajectory 104, thereby fully decomposing the ammonia at the highest theoretically possible ammonia-to-hydrogen conversion efficiency. The heat, released by the formation of water, is balanced with the heat, absorbed by the decomposition of ammonia, to give zero temperature rise when the reactions are run to completion. The enthalpies of formation of ammonia, water, or any other compound vary as a function of reaction temperature because, over a given temperature range, the total heat capacities of the reactants and products, in any given chemical equation, are not generally the same. Therefore the equivalence ratio for zero temperature rise also varies as a function of the reaction temperature. Each equivalence ratio on curve 202 is 1.5 times the molar enthalpy of formation of water, divided by the molar enthalpy of formation of ammonia, for each temperature. The enthalpy of formation assigns a value of zero to pure chemical elements in their usual form, for example, diatomic hydrogen.

The horizontal axis of graph 200 is labeled “Ammonia Cracking Temperature” because, for an excursion from point 108 to point 110 on trajectory 104, the reaction temperature is the ammonia cracking temperature 112. Real, non-catalyzed ammonia decomposition occurs at a finite rate which increases exponentially with increasing temperature. Therefore, the ammonia cracking temperature 112 increases slightly, with increasing ammonia/air mixture flow rate, and decrease slightly, with decreasing mixture flow rate, such that the ammonia decomposition rate matches the throughput rate. Experimental measurements of the ammonia cracking temperature 112 indicate that ammonia decomposes into hydrogen and nitrogen without the aid of a catalyst, at a high rate, and at a high attainable decomposition yield when the temperature is about 1200-1250° C. However, at very low flow the ammonia cracking temperature 112 may be 1150° C., and at very high flow the ammonia cracking temperature 112 may be 1300° C., for example. All actual ammonia cracking temperatures appear to be higher than about 1100° C. All ammonia cracking temperatures lower than about 1100° C. are hypothetical, because non-catalyzed ammonia decomposition does not occur at an appreciable rate for temperatures lower than about 1100° C. Curve 202 is shown for both the actual and the hypothetical ammonia cracking temperature regions, because its shape, in both regions, is relevant for additional discussion to follow.

At about 1100° C., curve 202 has a minimum of 6.66, and at that point the total heat capacities of the products and reactants are equal. For an Ammonia Flame Cracker incorporating an ideal counterflow heat exchanger in which the outgoing products are heat exchanged with the incoming reactants, the temperatures of the products and reactants will be equal where the total heat capacities are equal, at about 1100° C. The portion of the curve 202, for which the temperature is lower than about 1100° C., has a negative slope, indicating that the total heat capacity of the product mixture is greater than the total heat capacity of the reactant mixture. Therefore the product mixture contains more than enough heat to bring the reactant mixture up from ambient temperature to 1100° C.

However, the reactant mixture must also complete the excursion from 1100° C. to the ammonia cracking temperature 112 before it can react at point 108 on trajectory 104. For temperatures of interest which are higher than about 1100° C., curve 202 has a weakly positive slope, indicating that the total heat capacity of the reactant mixture is very slightly greater than the total heat capacity of the product mixture. However, this difference in total heat capacities is negligibly small. Therefore the product mixture contains enough heat to bring the reactant mixture up from 1100° C. to a temperature which is negligibly lower than the ammonia cracking temperature 112. The effect of this negligible temperature difference on the reaction energy balance can be exactly compensated by using the ammonia/air equivalence ratio=6.66, which is the minimum of curve 202, for all actual ammonia cracking temperatures.

Therefore, an ammonia/air mixture of equivalence ratio=6.66 has just sufficient internal chemical energy for completing a total excursion on trajectory 104 from ambient temperature near point 102 to having fully decomposed the ammonia at point 110, if the reactants and products are counterflow heat exchanged in an ideal heat exchanger. The theoretical upper performance limit for a heat exchanged Ammonia Flame Cracker thus corresponds to a full ammonia decomposition yield obtained at an equivalence ratio of 6.66, a hydrogen product mixture containing about 52% hydrogen by volume on a wet basis, or 58% on a dry basis, and an ammonia-to-hydrogen chemical energy conversion efficiency of 97.3%, on a lower heating value (LHV) energy basis. These calculated results for the theoretical upper performance limit do not depend on the particular values for either the ambient temperature or the ammonia cracking temperature 112. The ammonia-to-hydrogen conversion efficiency and equivalence ratio at the theoretical upper performance limit remain the same if pure oxygen or oxygen-enriched air is used instead of normal air. If pure oxygen is used instead of normal air, the hydrogen content of the product mixture, at the theoretical upper performance limit, changes to about 64% hydrogen by volume on a wet basis, or 72% on a dry basis. Therefore, the use of pure oxygen instead of normal air, during normal running, is thus of little advantage, although substantially pure oxygen can be usefully incorporated into a startup method.

A counterflow heat exchanged Ammonia Flame Cracker may have heat exchanger losses which cause a departure from the theoretical upper performance limit. If a product mixture ends its excursion on trajectory 104 at point 110, then the incoming reactant mixture may reach a preheated state which falls short of point 108, and thus the preheat temperature is somewhat lower than the ammonia cracking temperature 112, by a small temperature deficit. This temperature deficit or more generally, the product-to-reactant temperature drop, is a characteristic of the heat exchanger's losses. An ammonia/air mixture, which falls short of reaching the ammonia cracking temperature 112, can be made to react by flowing the mixture over a heater. The heater may be a non-catalytic, electrically driven heating element which is always turned on during operation. Preferably, the heater may be a catalytic filament or other catalyst, which heats the mixture by combustion of some of the ammonia, rather than by electrical heating. The catalyst decomposes some of the ammonia, releasing hydrogen, which immediately combines with oxygen, releasing heat. An appropriately designed catalyst should have sufficient distribution and catalytic activity, such that at least enough heat is released in the vicinity of the catalyst to raise the mixture temperature to the ammonia cracking temperature 112. When the mixture reaches the ammonia cracking temperature 112, the mixture undergoes an avalanche of water formation and ammonia decomposition, until all of the remaining oxygen is consumed, without requiring further assistance from the catalyst. Thus, the catalyst serves to initiate reactions, but the catalyst need not be sized for providing enough catalytic sites to catalyze all of the ammonia decomposition reactions. Most of the ammonia decomposition reactions occur in the avalanche reactions which are precipitated at the ammonia cracking temperature 112.

In one example, an outgoing product mixture reaches point 110 at the end of its excursion on trajectory 104, and the incoming reactant mixture reaches a preheat state corresponding to point 106 on trajectory 104. Point 106 is drawn for a preheat deficit of 100° C. below the ammonia cracking temperature 112, which can be overcome by a release of hydrogen, equivalent to the decomposition of about 3% of the ammonia on the catalyst. Prior art examples, which operate without the benefit of heat exchange, and without the benefit of avalanche reactions involving ammonia and oxygen at temperatures exceeding 1100° C., must therefore use about 30-40 times as much catalyst in order to fully decompose ammonia at the same rate.

A product mixture may end its excursion at a point somewhere above and to the right of point 110 on trajectory 104, thereby decomposing all of the ammonia. The product mixture ends its excursion on trajectory 104 at a post-reaction temperature which is somewhat higher than the ammonia cracking temperature 112, by a small temperature excess. If this temperature excess is at least as large as the product-to-reactant temperature drop due to heat exchanger losses, then the incoming ammonia/air mixture will reach point 108 on trajectory 104 and then fully react without the aid of any catalyst. Catalyst-free operation is advantageous because catalyst cost, placement, and durability can still be significant problems even for Ammonia Flame Crackers which use 30-40 times less catalyst than catalytic ammonia crackers which catalyze all of the ammonia decomposition reactions. Operation at post-reaction temperatures in excess of the ammonia cracking temperature 112 is advantageous because trace quantities of ammonia may still be present in the mixture at point 110 on trajectory 104, and even trace quantities of ammonia will decompose essentially completely at temperatures in excess of the ammonia cracking temperature 112.

If, by choice of ammonia/air equivalence ratio, the post-reaction temperature excess is made larger than necessary to ensure that the incoming reactant mixture will reach point 108 on trajectory 104, and thus ensure that the fully non-catalyzed operation won't extinguish, then the incoming reactant mixture will react at a location further upstream within the heat exchanger. The reactant mixture will not accept additional preheating beyond the ammonia cracking temperature 112 because it reacts spontaneously when it reaches the ammonia cracking temperature 112. Therefore a positive feedback regime, leading to thermal runaway, will not occur. The inertness of the ammonia/air mixture below the ammonia cracking temperature 112, and the mixture's inability to accept additional preheating beyond the ammonia cracking temperature 112, ensures the inherent stability of the operation of a heat exchanged Ammonia Flame Cracker.

In one example, an outgoing product mixture reaches point 114 at the end of its excursion on trajectory 104. Point 114 is drawn appropriately for a temperature excess of 100° C. above the ammonia cracking temperature 112, sufficient to overcome a 100 degree heat product-to-reactant temperature drop, due to heat exchanger losses, and thus move the incoming reactant mixture to a preheat state corresponding to point 108 on trajectory 104. Whether the product-to-reactant temperature drop, due to heat exchanger losses, is taken up in a reactant temperature deficit, or a product temperature excess, an equivalence ratio of somewhat less than 6.66 can be used to compensate for heat exchanger losses.

if no catalyst is used in a counterflow heat exchanged Ammonia Flame Cracker, and if the incoming ammonia/air mixture fails to reach point 108 on trajectory 104, then the ammonia/air mixture will not react at all and the non-catalytic Ammonia Flame Cracker will cease to produce hydrogen. A catalyst-free, counterflow heat exchanged Ammonia Flame Cracker is thus capable of go/no-go functionality, wherein either all of the ammonia decomposes when the reacting mixture moves beyond point 110 on trajectory 104, or else it doesn't react at all. Thus the catalyst-free, counterflow heat exchanged Ammonia Flame Cracker will not continue to operate if there is substantial ammonia content in the product mixture. An engine or other combustion system incorporating a catalyst-free, counterflow heat exchanged Ammonia Flame Cracker will stall, extinguish or otherwise stop, rather than continue to operate with substantial quantities of ammonia, or undesirable minor products of ammonia combustion, such as nitrous oxide, in the exhaust.

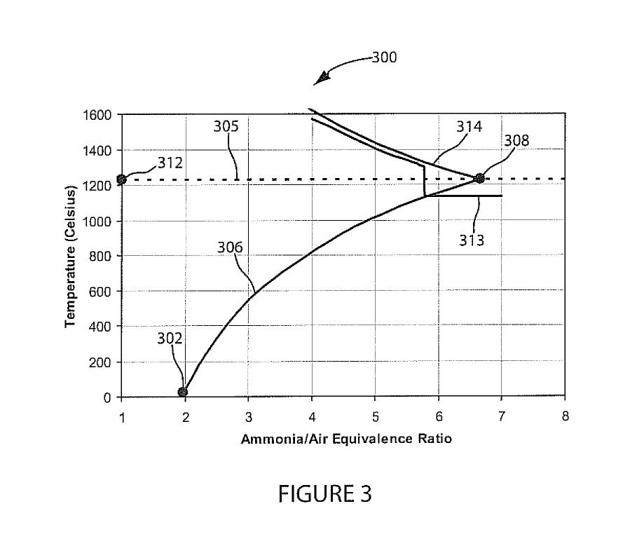

Referring to FIG. 3, a graph 300 is shown, and this graph contains information about a more general case of Ammonia Flame Cracker operation. The air is modeled as consisting of 21% oxygen and 79% nitrogen by volume, and the ammonia cracking temperature 312 is assumed to be 1500 Kelvin=1227° C., for the calculation of the curves in graph 300. Horizontal dashed line 305 shows the placement of features in graph 300 in relation to the ammonia cracking temperature 312. The theoretical upper performance limit is covered in this description, and graph 300, also covers cases for which the actual performance, of an Ammonia Flame Cracker, departs from the previously described theoretical upper performance limit.

A rich ammonia/air reactant mixture may be preheated to a temperature corresponding to a point somewhere between points 102 and 108 on trajectory 104 just before reactions are started on a catalyst. Once started, the reactions are assumed to proceed adiabatically, and the heat released, by the exothermic formation of water, moves the mixture along trajectory 104 toward point 110. The portion of curve 306, between points 302 and 308, describes combinations of preheat temperature and ammonia/air equivalence ratio, for which just enough heat is released, by the exothermic formation of water, to move the mixture from the preheat temperature corresponding to a point somewhere between points 102 and 108, to point 110 on trajectory 104, when all of the oxygen is consumed. A substantially full ammonia decomposition yield is thus obtained. Point 302 on curve 306 corresponds to a preheat temperature of 25° C., and for point 302, the ammonia/air equivalence ratio is 1.98. Therefore, when the ammonia/air equivalence ratio is 1.98, just enough heat is released, by the exothermic formation of water, to move the mixture from point 102 to point 110 on trajectory 104 when all of the oxygen is consumed. An ammonia/air mixture cannot be preheated beyond the ammonia cracking temperature 312 before the reactions begin, because the mixture reacts spontaneously at the ammonia cracking temperature 312. Therefore curve 306 ends at the ammonia cracking temperature 312, here assumed to be 1227° C., at point 308, which is drawn on horizontal dashed line 305 directly across from the ammonia cracking temperature 312. Point 308 corresponds to a preheat temperature which is equal to the ammonia cracking temperature 312 and a preheat condition corresponding to point 108 on trajectory 104. For point 308, an equivalence ratio is selected, such that just enough heat is released, by the exothermic formation of water, to move the mixture from point 108 to point 110 on trajectory 104 when all of the oxygen is consumed. Point 308 thus corresponds to the previously described theoretical upper performance limit, and is assigned an ammonia/air equivalence ratio of 6.66.

A rich ammonia/air reactant mixture may be preheated to the ammonia cracking temperature 312, whereupon the mixture reacts spontaneously and without the aid of a catalyst. The mixture remains inert during preheat until it reaches the ammonia cracking temperature 312. However, the mixture will not accept additional preheating beyond the ammonia cracking temperature 312 because it reacts spontaneously when it reaches the ammonia cracking temperature 312. Therefore the starting temperature of the reactions is the ammonia cracking temperature 312. Once started, the reactions are assumed to proceed adiabatically, and the heat released, by the exothermic formation of water, moves the mixture to a state of full ammonia decomposition and a post-reaction temperature which equals or exceeds the ammonia cracking temperature 312. Curve 314 describes combinations of ammonia/air equivalence ratio and post-reaction temperature reached by a mixture that began reacting when the mixture reached the ammonia cracking temperature 312. Curve 314 happens to be very nearly a mirror image of curve 306 about dashed line 305. No minimum ammonia/air equivalence ratio is specified for curve 314. However, curve 314 climbs with decreasing equivalence ratio, and in practice it is necessary to keep the ammonia/air equivalence ratio above a chosen minimum value, for example about 4, such that the post-reaction temperature of the gas mixture does not exceed durability limits of materials, from which an Ammonia Flame Cracker is constructed. Curve 314 ends at the ammonia cracking temperature 312, and at an equivalence ratio for which just enough heat is released, by the exothermic formation of water, to move the mixture from point 108 to point 110 on trajectory 104 when all of the oxygen is consumed. Therefore, curve 314 ends at the same point 308, at which curve 306 also ends, and at the same ammonia/air equivalence ratio of 6.66.

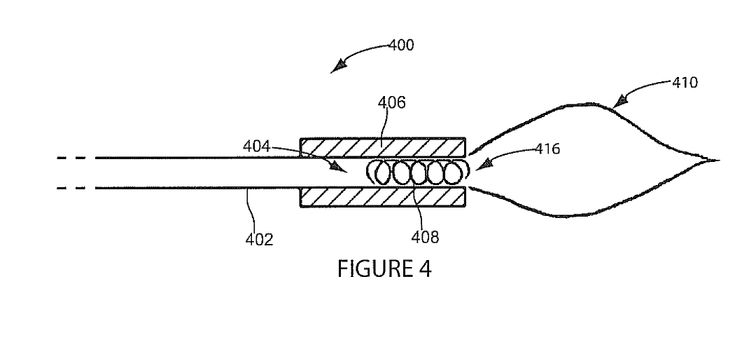

Referring to FIG. 4, according to one representative embodiment, the Ammonia Flame Cracker 400 includes a tubing 402, an insulating layer 406 and a heater 408. The tubing 402 is constructed of materials, for example, ceramics, chosen to withstand the high temperature and the chemical environment of a combusting ammonia/air mixture. The tubing 402 may also be substantially devoid of catalytic activity in regions upstream of the heater 408. The ammonia/air equivalence ratio and total mixture mass flow may be controlled by devices (not shown) placed upstream or downstream of the tubing 402 which are known to the art, including but not limited to: valves, pumps, restrictors, venturi tubes, aspirator tubes, gas regulators, components of an engine, or any means involving the utilization of the ammonia's elevated tank pressure. The working pressure inside tubing 402 may be about 1 atmosphere, but in some cases it may be substantially higher or lower than 1 atmosphere. An insulating layer 406, is useful for maintaining a stable profile of temperature and possible catalytic activity on heater 408. The insulating layer 406 may consist of various layers, including but not limited to one or more of the following: fibrous insulation, layers of metal film, one or more optical coatings, and one or more vacuum jackets, which are intended to reduce convective, conductive and radiative losses from the heater region. The insulating layer 406 substantially reduces a possibly otherwise large and unknown heat loss through the side of the tubing 402. This heat loss, if not controlled or minimized, could render the flame cracking process to be substantially non-adiabatic, which may significantly complicate the control of the Ammonia Flame Cracker 400. The insulating layer 406 may be omitted for instances in which the flame cracking process occurring in the vicinity of heater 408 can be rendered substantially adiabatic by means other than inclusion of insulating layer 406, for example, by making tubing 402 and heater 408 sufficiently large.

The Ammonia Flame Cracker 400 does not include a provision for heat exchanging the reactants and products outside the region of heater 408, although a gas mixture can borrow heat and then return it to/from heater 408 in a way that can be construed as a heat exchange process. The state of the gas mixture in region 404 may thus correspond to ambient temperature near point 102 on trajectory 104. More generally, the state of the gas mixture in region 404 corresponds to a point somewhere below and to the left of point 108 on trajectory 104. A temperature probe (not shown) may be placed in region 404, and the ammonia/air equivalence ratio and/or electric power applied to heater 408 may be controlled according to this temperature probe's reading. The heater 408 may be a non-catalytic, electrically driven heating element which is always turned on during operation. Preferably, the heater 408 may be a catalytic filament or other catalyst, which heats the mixture by combustion of some of the ammonia, rather than by electrical heating. Heater 408 may also be a catalyst which is electrically heated only during startup. Hereafter the heater 408 will be called a catalyst 408.

An ammonia/air equivalence ratio may be selected such that the ammonia/air mixture has at least enough oxygen to complete an excursion to point 110 on trajectory 104 when all of the oxygen is consumed. In some instances, the gas temperature in region 404 may be lower than the light-off temperature of the catalyst 408. Although the ammonia/air mixture may have enough oxygen to react until it reaches point 110 on trajectory 104, the gas temperature must first be raised before it can react. However, the incoming ammonia/air mixture borrows a small quantity of heat, from the catalyst 408, sufficient to raise the mixture to a temperature at which it will react on the catalyst 408. The borrowed heat is then immediately returned to the catalyst 408 when the mixture reacts. The mixture behaves as though it is simply made to react on the catalyst 408, and the total energy balance, which determines the location where the mixture ends its excursion on trajectory 104, is otherwise unaffected by the presence of the catalyst 408.

If no electric power is applied to catalyst 408 during normal running, then the catalyst 408 must be designed to have sufficient distribution and catalytic activity, such that enough heat is released in the vicinity of the catalyst 408 to move the mixture at least far enough on trajectory 104 to reach the ammonia cracking temperature 112. Once the mixture reaches the ammonia cracking temperature 112, the mixture undergoes an avalanche of water formation and ammonia decomposition, until all of the remaining oxygen is consumed, without requiring further assistance from the catalyst 408. Thus, the catalyst 408 serves to initiate reactions, but the catalyst 408 need not be sized for providing enough catalytic sites to catalyze all of the ammonia decomposition reactions.

A stable temperature and catalytic activity profile on catalyst 408 can be maintained if the adiabatic flame temperature of the ammonia/air mixture is high enough. Experiments showed that when the gas temperature in region 404 is about 25° C., the catalyst 408 maintains a stable temperature and catalytic activity profile with the electric power turned off when the ammonia/air equivalence ratio is less than about 2. Calculations show that, at an ammonia/air equivalence ratio of 1.98, just enough heat is released, by the exothermic formation of water, to move the mixture from point 102 to point 110 on trajectory 104 when all of the oxygen is consumed. It appears that a stable profile of temperature and catalytic activity on catalyst 408 can be readily maintained if the reacting gas mixture has enough oxygen to at least reach point 110 on trajectory 104.

Although Ammonia Flame Cracker 400 does not include a provision for preheating the ammonia/air mixture before it reaches the catalyst 408, the gas temperature in region 404 may be elevated substantially above ambient temperature for operation of an Ammonia Flame Cracker 400 within a turbine or other elevated temperature environment. Elevated temperatures, in region 404, are functionally equivalent to preheating. If no electric power is applied to catalyst 408 during normal running, then curve 306 describes ammonia/air equivalence ratios for which the reactant mixture has just enough oxygen to complete an excursion to point 110 on trajectory 104. The gas temperature in region 404 is the preheat temperature for curve 306.

Ammonia Flame Cracker 400 may be started by heating at least a portion of tubing 402 or the catalyst 408, to a high temperature possibly exceeding the ammonia cracking temperature. This heating at startup can be accomplished by electrical resistive heating of components of Ammonia Flame Cracker 400, or by combustion of chemicals and subsequent passage of these combusted chemicals over surfaces within the Ammonia Flame Cracker 400. Fuels stored separately from the ammonia may be combusted with air or with ammonia and air, or ammonia may be combusted with substantially pure oxidizers or with oxidizer-enriched air, or with air. Burners and/or igniters (not shown) such as electric arcs, flame holders, or catalysts, which are dedicated to combustion of chemicals during startup of ammonia flame cracker 400, may be placed in communication with region 404. In some cases, the chemicals combusted during startup may form a combustible mixture when they react, and this combustible mixture may be used to immediately start and run a turbine or other combustion apparatus while the Ammonia Flame Cracker 400 warms up.

In some applications, the chemical energy and the sensible heat contained within a hot hydrogen-containing product mixture may be of equal value. Such as the case for operation of an Ammonia Flame Cracker 400 within the combustion zone of a turbine, or for operation of an Ammonia Flame Cracker 400 as a gas burner in a cooking or heating appliance. The hot hydrogen-containing product mixture, exiting through region 416, may be immediately combusted in a flame 410, which burns in the surrounding air. The resulting total heat release, due to combusting the hydrogen in flame 410, and also due to the hydrogen-containing product mixture's sensible heat in region 416 prior to combustion in flame 410, is equal to the heat release which would be obtained if the ammonia were fully combusted in a single-step process. Thus the maximum attainable thermal efficiency of the Ammonia Flame Cracker 400, taken on the basis of sensible heat and hydrogen out over ammonia in, may approach 100%.

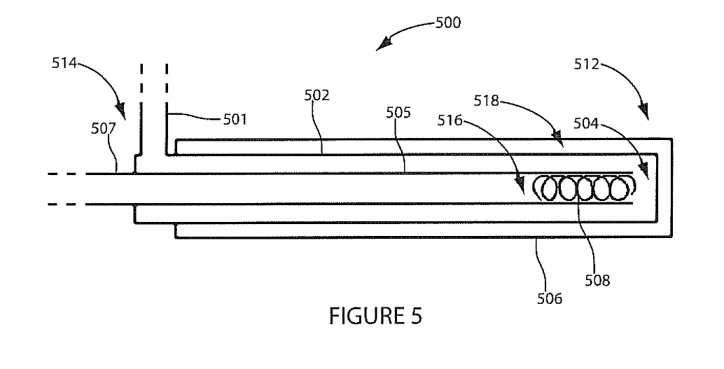

Referring to FIG. 5, according to one embodiment, an Ammonia Flame Cracker 500 includes tubings 502, 505, and 506, and a heater 508. The heater 508 may be a non-catalytic, electrically driven heating element which is always turned on during operation. Preferably, the heater 508 may be a catalytic filament or other catalyst, which heats the mixture by combustion of some of the ammonia, rather than by electrical heating. Heater 508 may also be a catalyst which is electrically heated only during startup. Hereafter the heater 508 will be called a catalyst 508. The tubings 502 and 505 are joined near end 514 and constructed of materials, for example, ceramics, chosen to withstand the high temperature and the chemical environment of a combusting ammonia/air mixture, and also for appropriate electrical and thermal properties. The Ammonia Flame Cracker 500 combusts and decomposes a rich, premixed ammonia/air mixture in the vicinity of a catalyst 508 in much the same manner as does the Ammonia Flame Cracker 400 on catalyst 408. Additionally, the Ammonia Flame Cracker 500 incorporates provisions for preheating the incoming ammonia/air reactant mixture, before it reaches catalyst 508, by heat exchange, using the sensible heat contained in the outbound hydrogen-containing product mixture. This transfer of heat, from the outbound hydrogen-containing product mixture to the incoming ammonia/air reactant mixture, occurs by heat conduction and/or radiation through the walls of tubing 505.

A rich, premixed ammonia/air mixture enters the Ammonia Flame Cracker 500 through inlet 501 and travels through the space between tubings 502 and 505 until the mixture reaches region 504. The ammonia/air mixture reacts in the vicinity of catalyst 508, at which the ammonia/air mixture becomes a hydrogen-containing product mixture. Finally, the hydrogen-containing product mixture travels toward exit 507, through the space inside tubing 505, and leaves the Ammonia Flame Cracker 500 through exit 507. Although the Ammonia Flame Cracker 500 could be operable with the flow going in the direction opposite of that described, the flow direction was chosen to direct the heat inward. Any heat ultimately lost through tubing 502 and then tubing 506 must first pass through the space between tubings 502 and 505.

The gas temperature in region 504 may typically be higher than the light-off temperature of the catalyst 508. The mixture behaves as though it is simply made to react on the catalyst 508, and the state of the mixture at the end of its excursion on trajectory 104 is otherwise unaffected by the presence of the catalyst 508. A stable profile of temperature and catalytic activity on catalyst 508 is maintained for a wide range of operating conditions. Experiments showed that the catalyst 508 retains a stable profile of temperature and catalytic activity even when the reacting gas mixture doesn't have enough oxygen to reach a full ammonia decomposition yield, and thus the mixture ends its excursion on trajectory 104 somewhere between points 108 and 110. It appears that a stable profile of temperature and catalytic activity on catalyst 508 can be readily maintained if the reacting gas mixture has enough oxygen to at least reach the ammonia cracking temperature 112.

Tubing 506 is joined to tubing 502 near end 514 and it forms the outer wall of a vacuum jacket, and tubing 502 forms the inner wall of this same vacuum jacket. Vacuum space 518 is thus bounded by the inner surface of tubing 506 and the outer surface of tubing 502. This vacuum space prevents conductive and convective heat loss from Ammonia Flame Cracker 500. Tubing 506 may be constructed of materials which are forbidden for use in portions, near end 512, of tubings 502 and 505. For example, some portions of tubings 502 and 505, especially portions near end 512, must be constructed of materials that can withstand temperatures near 1250° C. or higher, whereas tubing 506 may be constructed of materials which may melt at this temperature, for example, glasses, metals, and high reflectivity coatings that melt at temperatures which are lower than the ammonia cracking temperature 312. The inner surface of tubing 506 may be coated with a metal film, for example gold, silver, copper or aluminum, which has a high average reflectivity for blackbody radiation at 1250° C. The high reflectivity coating on the inner surface of tubing 506 reduces radiative heat loss from tubing 502, and also helps to keep tubing 506 relatively cool.

The portions of the outer surface of Ammonia Flame Cracker 500 may be fitted with cooling fins (not shown), a fan (not shown) or constructed from/coated with a material chosen for a high average emissivity for blackbody radiation near ambient temperature, which will further cool tubing 506 and reduce the thermal stresses on all tubings and any of their joints and coatings. Additionally, the outer surface of tubing 502 may be coated with a film, for example tantalum or others which are at least moderately reflective and can withstand the highest temperature reached on portions of tubing 502. Additional reflective film or foil layers may also be inserted in the vacuum space 518 between the inner surface of tubing 506 and the outer surface of tubing 502. The aspect ratio of the Ammonia Flame Cracker 500 may be chosen to minimize radiative and conductive heat transfer down the length. Further insulation on the outside of tubing 506 only serves to raise the temperature of tubing 506, and has minimal impact on the rate of net heat loss from tubing 502.

Generally, a heat exchanger geometry, possibly differing from that shown in 500, may be chosen to improve heat exchange or to impede heat loss. For example, multiple tubings 505 and catalysts 508 may be housed within tubing 502. In another example, an extruded silicon carbide or other ceramic brick with hollow channels, similar in shape and dimension to those used as the supporting matrix in automotive exhaust catalysts, may be used in place of the single tubing 505. Such a ceramic brick may contain, for example, an N by N array of square channels, wherein adjacent channels alternate between connection to reactant entry 501 and product exit 507. The complexity of connecting reactant entry 501 and product exit 507 to the ceramic brick, with this configuration, is proportional to N squared. If adjacent rows alternate between connection to reactant entry 501 and product exit 507, wherein all channels in a given row carry either reactants or products but not both, then the complexity of connecting reactant entry 501 and product exit 507 to the ceramic brick is proportional to N. A ceramic brick with N flat channels alternating between connection to reactant entry 501 and product exit 507 may also be used, and for this the complexity of connecting reactant entry 501 and product exit 507 to the brick is also proportional to N.

The inlet 501 may be positioned off-center for the purpose of imparting swirl flow in the region between tubings 502 and 505. Other measures such as fins and turbulent elements (not shown) and choice of material for tubing 505 may also facilitate the heat exchange process. A temperature gradient exists along the length of the Ammonia Flame Cracker 500, such that the end 512 containing the catalyst 508 may be near the ammonia cracking temperature of about 1200-1250° C., or higher, and the end 514 with the reactant entry 501 and product exit 507 may have a temperature of, for example, lower than about 300° C. Materials and fabrication methods used in the construction and joining of tubings 502 and 505, and tubings 502 and 506, may thus be permitted at end 514, which may not be permitted at end 512, for example, a-rings, metals, glasses, and glass-to-ceramic seals. The gas temperature in region 504 immediately upstream of the catalyst 508 may vary, and a temperature probe (not shown) placed in region 504 may provide information according to which the ammonia/air equivalence ratio and/or electric power applied to the catalyst 508, or applied to tubing 502 and/or tubing 505, may be controlled. If no electric power is applied to catalyst 508 during normal running, and the gas temperature in region 504 is lower than the ammonia cracking temperature 312, then curve 306 describes ammonia/air equivalence ratios for which the reactant mixture has just enough oxygen to complete an excursion to point 110 on trajectory 104. The gas temperature in region 504 is the preheat temperature for curve 306.

If, as the result of choice of equivalence ratio, the temperature in region 516 downstream of the catalyst 508 is made to exceed the ammonia cracking temperature 312, then it is possible for the gas temperature, somewhere within the space between tubings 502 and 505, to equal or exceed the ammonia cracking temperature 312. In that case, the ammonia/air mixture ignites and decomposes in the space between tubings 502 and 505 before reaching the catalyst 508, and the catalyst 508 may be omitted. A new, fully non-catalytic embodiment of Ammonia Flame Cracker 500 thus emerges with the omission of catalyst 508. If no electric power is applied to Ammonia Flame Cracker 500 during normal running, and if the ammonia/air mixture ignites and decomposes in the space between tubings 502 and 505 before reaching region 504, then curve 314 describes the post-reaction temperature of the product mixture in region 504 at different ammonia/air equivalence ratios.

Curve 313 describes the temperature in region 504 of Ammonia Flame Cracker 500 at different ammonia/air equivalence ratios. Curve 313 is a “performance curve” and is representative of a family of curves (not shown) which characterize the mixture preheating effectiveness of a heat exchanged Ammonia Flame Cracker 500. In this particular example, Curve 313 was calculated for an Ammonia Flame Cracker 500 which has a product-to-reactant temperature drop of about 100° C., which is thought to be representative of a practical design center. In this particular example, the product-to-reactant temperature drop is mostly due resistance to heat flow between the inside and outside of tubing 505, but it also includes effects of a relatively small heat loss through the vacuum space 518. During operation of Ammonia Flame Cracker 500 on portions of curve 313 which are below and to the right of curve 306, the reacting gas mixture ends its excursion on trajectory 104 before reaching point 110, and there is a large ammonia fraction in the product mixture. During operation of Ammonia Flame Cracker 500 on the intersection of curves 313 and 306, the reacting gas mixture ends its excursion on trajectory 104 at point 110, and there may be a small ammonia fraction in the product mixture. During operation of Ammonia Flame Cracker 500 on portions of curve 313 which are between curve 306 and line 305, the reacting gas mixture ends its excursion on trajectory 104 somewhere slightly above and to the right of point 110, but the temperature in the space between tubings 502 and 505 is not yet high enough to ignite the mixture before it reaches the catalyst 508, and there may be traces of ammonia in the product mixture. During operation of Ammonia Flame Cracker 500 on portions of curve 313 which are above line 305, the incoming ammonia/air mixture reacts before reaching the catalyst 508, the gas temperature in region 504 closely tracks curve 314, and there is essentially no ammonia in the product mixture. If an Ammonia Flame Cracker 500 is designed or controlled to consistently operate on portions of a performance curve, similar to curve 313, which are above line 305, thereby igniting the mixture before it reaches the catalyst 508, then catalyst 508 may be omitted.

Ammonia Flame Cracker 500 may be started by heating at least a portion of tubing 502 and/or tubing 505, or the catalyst 508, to a high temperature possibly exceeding the ammonia cracking temperature 312. This heating at startup may be accomplished by electrical resistive heating of components of Ammonia Flame Cracker 500, or by combustion of chemicals and subsequent passage of these combusted chemicals over surfaces within the Ammonia Flame Cracker 500. Fuels stored separately from the ammonia may be combusted with air or with ammonia and air, or ammonia may be combusted with substantially pure oxidizers or with oxidizer-enriched air, or with air. Burners and/or igniters (not shown) such as electric arcs, flame holders, or catalysts, which are dedicated to combustion of chemicals during startup of ammonia flame cracker 500, may be placed within or in communication with region 504. The chemicals, once combusted, may be introduced into region 504, and from there the combusted chemicals travel through the space inside tubing 505, toward exit 507, and leave through exit 507. In some cases, the chemicals combusted during startup may form a combustible mixture when they react, and this combustible mixture may be used for immediately starting and running an engine or other combustion apparatus while the Ammonia Flame Cracker 500 warms up. In some cases, the combusted chemicals may be introduced into region 504 and purged through from region 504 to exit 507 at a very high rate during startup of ammonia flame cracker 500.

In some applications, only the chemical energy in the hydrogen-containing product mixture has value, and the hydrogen-containing product mixture's sensible heat, at possibly high temperatures, does not have value and may even present one or more problems. Such is the case for operation of an Ammonia Flame Cracker 500 for supplying hydrogen into an uncompressed zone of an engine, for example, the intake line of a piston engine. Ammonia Flame Cracker 500 is suitable for these applications, because most of the sensible heat of the hot hydrogen-containing product mixture is recuperated into the incoming ammonia/air reactant mixture, thus raising the gas temperature in region 504 and lowering the hydrogen-containing product mixture's temperature before exiting through product outlet 507. An elevated gas temperature in region 504 permits the use of a higher range of equivalence ratios, while obtaining full ammonia decomposition yield, than would be permitted without recuperation of heat, according to curve 306. The heat required to bring the ammonia up from ambient temperature to the ammonia cracking temperature 312 is a large portion of an Ammonia Flame Cracker's total energy budget. At high equivalence ratios (for example, greater than about 5), most of the total heat release, obtained from using ammonia, occurs in the combustion of the hydrogen-containing product mixture. The hydrogen-containing product mixture may be combusted in a region distant from the Ammonia Flame Cracker 500, for example, inside a combustion chamber of an engine, or a turbine or other burner such as a heating appliance. In some instances, only a small fraction (for example, less than 5%) of the chemical energy contained in the ammonia is lost during conversion of ammonia to hydrogen by the Ammonia Flame Cracker 500.

The Ammonia Flame Cracker 500 may also be used in applications which utilize both the heat released by combusting the hydrogen-containing product mixture, and the hydrogen-containing product mixture's sensible heat prior to combustion. Such is the case for operation of Ammonia Flame Cracker 500 supplying combustible gas to a turbine, a burner, or another heating appliance. Thus the efficiency of the Ammonia Flame Cracker 500, taken on the basis of chemical energy and sensible heat of the hydrogen-containing product mixture out, over ammonia, in, may approach 100% if the heat loss, through vacuum space 518 and end 514, is recovered or made comparatively very small.

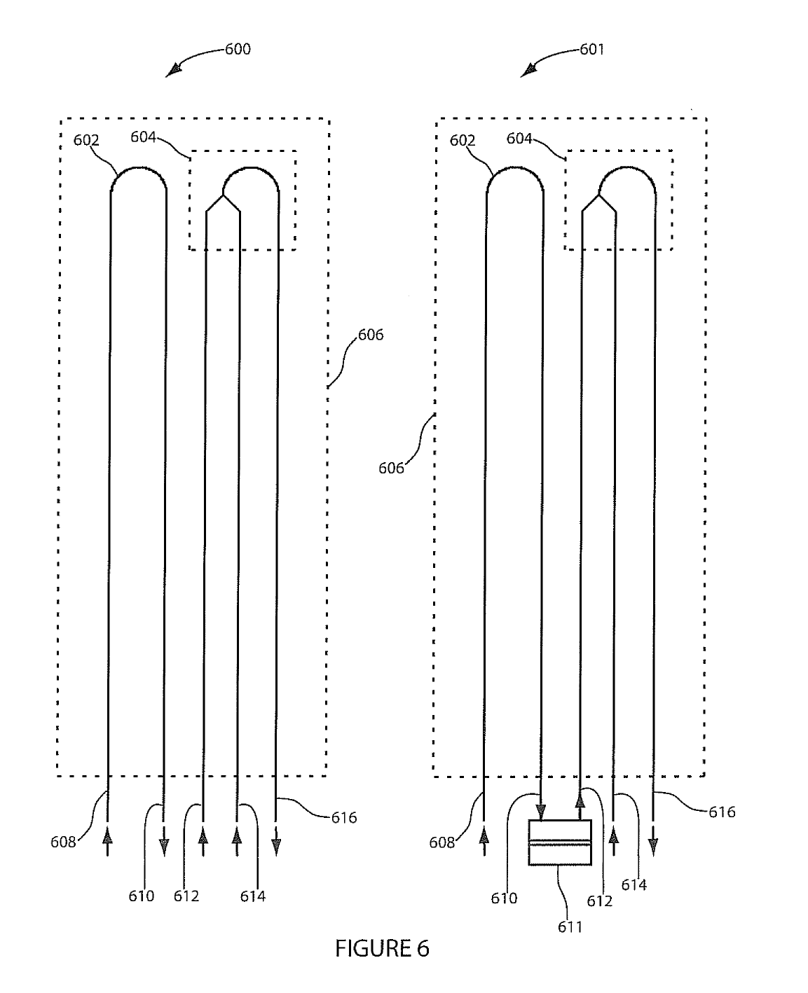

Referring to FIG. 6, a heat exchanged ammonia flame cracker 600 with separate ammonia combustion and ammonia decomposition loops, and system 601 are shown. The theoretical upper performance limits concerning energy balance, ratio of ammonia cracked to ammonia combusted, and efficiency are all the same for ammonia crackers 500 and 600. Ammonia enters port 608, is brought up to a temperature at which ammonia decomposes at a high rate without the aid of a catalyst, decomposes in the endothermic decomposition loop 602, and is brought back down in temperature before exiting port 610. If the ammonia fully decomposes in loop 602, then the mixture exiting port 610 will contain 75% hydrogen and 25% nitrogen by volume. A fuel gas enters port 612 and air enters port 614. The fuel gas may be ammonia, or it may be a portion of the decomposed mixture exiting from port 610. The fuel gas and air are preheated separately, then mixed and then burned in a burner 604. The burner may mix the fuel gas and air in a distributed way such that the heat release is spread out, thus lowering peak temperatures in the burner 604 and facilitating heat transfer from burner 604 to endothermic decomposition loop 602. At least enough air is supplied to the burner 604 such that all of the fuel gas is combusted, and more than sufficient air may be used for the purposes of balancing heat capacities between the exothermic loop containing the burner 604 and the endothermic loop 602, for reducing NOx emissions by the burner 604, for lowering peak temperatures in the burner 604, or to ensure the complete burnup of the fuel gas entering port 612. The fuel gas entering port 612 and air entering port 614 may be mixed in stoichiometric proportions in burner 604, such that any small quantities pollutants in the exhaust gas may be completely removed with an exhaust cleanup catalyst (not shown) before exiting port 616. Heat is recovered from the exhaust gas after it leaves the burner 604, and before it exits from port 616. Generally, a heat exchange relationship may exist between any two or all elements contained within the heat exchanger 606. In particular, heat is transferred from the burner 604 to the endothermic decomposition loop 602.

Ammonia Flame Cracker 600 may be operated as a stand alone device, or it may be incorporated into an engine system or other system for a combustion apparatus. Ammonia Flame Cracker 600 may be further used in applications which require a hydrogen-containing product gas which is devoid of moisture and residual oxygen. These applications include annealing, brazing, heat treat, and use of the hydrogen-containing product mixture as a combustion promoter for an engine which burns mostly raw ammonia. For other applications it is advantageous to obtain a hydrogen-containing product gas which is of reduced nitrogen content and devoid of other impurities, and thus requires less work to purify the hydrogen by means known to the art. These include use of the hydrogen as a lift gas for a balloon and the generation of high purity tank hydrogen.

Ammonia Flame Cracker 600 may be incorporated into a fueling system 601 for a fuel cell 611. Ammonia enters port 608, is decomposed in loop 602, and the hydrogen gas mixture, exiting from port 610, is fed into the fuel cell 611. A portion of the hydrogen is consumed by the fuel cell 611, and the hydrogen-depleted mixture is used as the fuel gas which enters port 612. System 601 may be operated toward the advantages that none of the fuel is wasted, no gas separators are needed, Ammonia Flame Cracker 600 and system 601 may be fully non-catalytic, impurities do not accumulate in the fuel cell 611, throughput is not limited by quantity of catalyst, and the Ammonia Flame Cracker 600 and system 601 may be operated with ammonia and normal air as the only inputs. Ammonia Flame Cracker 600 and system 601 may be started by resistive heating of one or more elements contained in the heat exchanger 606, or they may be started by combustion of ammonia with air or oxidizers, or other fuels with air in the burner 604.

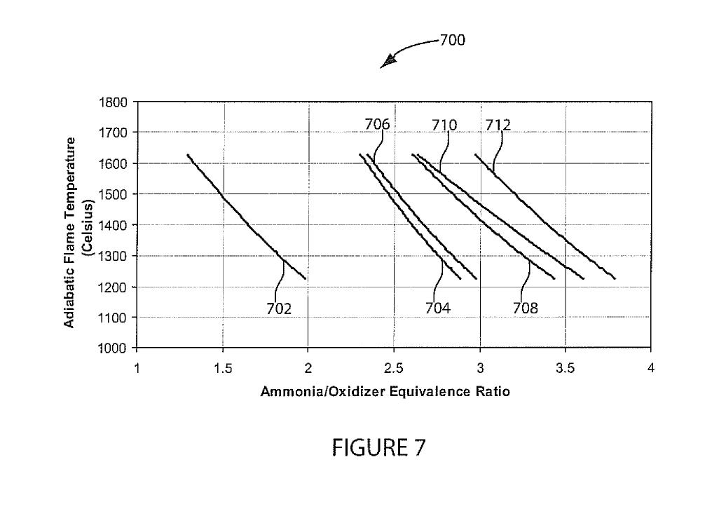

Referring to FIG. 7, a graph 700 is shown of the adiabatic flame temperature of mixtures of ammonia with various oxidizers, at different ammonia/oxidizer equivalence ratios. The curves in graph 700 were calculated using the following assumptions: air consists of a mix of 79% nitrogen and 21% oxygen by volume, the ammonia cracking temperature is 1500 Kelvin=1227° C., the ammonia and all oxidizers are delivered to a reaction zone in gaseous form and without impurities (such as water or nitrogen), and the initial temperature of the ammonia/oxidizer mixture is 25° C. Air is not referred to as a pure oxidizer here, due to its high nitrogen content. Also, the effects of other energy inputs, such as electric arcs, resistive heating, heat exchange into the mixture prior to combustion, and additional air for further burning of the mixture, are ignored. Curves 702, 704, 706, 708, 710, and 712 correspond to ammonia/oxidizer mixtures in which the oxidizer is air, oxygen, nitrogen dioxide, nitrous oxide, hydrogen peroxide, and nitric oxide, respectively. At least some of these oxidizers will support combustion in a normal flame in at least a portion of the equivalence ratio range shown, without the need for catalysts or preheating of the mixture. For example, rich ammonia/oxygen mixtures were found to burn quite readily at equivalence ratios less than about 2.4. These mixtures may be combusted by various means disclosed herein or known to the art, and the burned mixture may then be flowed over surfaces within Ammonia Flame Crackers 400, 500 and 600 for the purpose of bringing portions of Ammonia Flame Crackers 400, 500 and 600 up to operating temperature.

The rightmost points of curves 702, 704, 706, 708, 710, and 712 correspond to sufficient quantities of oxidizer in the mixtures to move the mixtures from point 102 to point 110 on trajectory 104, and thus decompose all of the remaining ammonia at an adiabatic flame temperature which is the ammonia cracking temperature, assumed to be 1227° C. The leftmost points correspond to a chosen maximum adiabatic flame temperature of 1900 Kelvin=1627° C., which exceeds the ammonia cracking temperature by a wide margin and is near the durability limit of silicon carbide. For a broad class of pure oxidizers, ammonia/oxidizer equivalence ratios in the range of 2 to 3.5 appear to be appropriate for bringing Ammonia Flame Crackers up to an operating temperature which is higher than the ammonia cracking temperature 112 and lower than the maximum tolerable temperature for some specific materials. Rich mixtures of ammonia and pure oxidizers also make flammable hydrogen gas mixtures when they react, and these flammable mixtures may be used to run an engine or other combustion apparatus while the Ammonia Flame Cracker is warming up. Otherwise, the mixture may simply be purged through the Ammonia Flame Cracker, or mixed with additional air and burned for additional heat within the Ammonia Flame Cracker, at gas temperatures exceeding material durability limits, if controls are provided, which permit doing so safely.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Having described our invention, we claim:

1. A method of cracking gaseous ammonia, comprising the steps of:
providing a conduit having an inlet and an outlet;
flowing a premixed, ammonia-rich gaseous mixture of anhydrous ammonia and air into the inlet of the conduit;
heating the mixture to a temperature high enough for rapid and substantially non-catalyzed decomposition of ammonia in bulk;
wherein the mixture, thus heated, undergoes a gaseous-phase avalanche of water formation reactions and ammonia decomposition reactions; in portions of the gas not associated with the heating process, and
outputting a mixture of gaseous products, resulting from the reactions, from the outlet of the conduit, the mixture including non-combusted hydrogen gas.

2. The method of claim 1, further comprising the steps of:
providing a heating element within the conduit; and
wherein at least a portion of the heating results from a portion the gaseous mixture making contact with the heating element.

3. The method of claim 1, further comprising the steps of:
providing a counterflow heat exchanger within the conduit; and
wherein at least a portion of the heating results from a transfer of heat from the mixture of gaseous products to the mixture of anhydrous ammonia and air.

4. The method of claim 2, wherein the heating element is constructed from one or more of the following, elements: carbon, silicon, iron, cobalt, nickel, chromium, molybdenum and a platinum-group metal.

5. The method of claim 2, including the step of choosing the dimensions, geometry, and materials of the heating element so as to initiate flamelets of combustion on a sufficiently wide distribution of points that the respective flamelets traverse the burning gas mixture before it travels appreciably far from the region immediately adjacent the element.

6. The method of claim 2, including the step of choosing the dimensions, geometry, and materials of the heating element so as to catalyze enough ammonia combustion reactions such that the heating of the mixture is sufficient to reach a temperature high enough to precipitate the gaseous-phase avalanche of chemical reactions involving water formation and ammonia decomposition.

7. The method of claim 3, including the step of choosing the ammonia/air equivalence ratio of the incoming mixture so as to obtain heating of the mixture, sufficient to reach a temperature high enough to precipitate the gaseous-phase avalanche of chemical reactions involving water formation and ammonia decomposition.

8. The method of claim 3, including the step of choosing the ammonia/air equivalence ratio of the incoming mixture so as to obtain an optimal ammonia decomposition yield.

9. The method of claim 1, further including the step of storing the hydrogen for later use.

10. The method of claim 1, further including the step of using the hydrogen as a combustion promoter for an engine or other combustion apparatus.

11. The method of claim 1, further including the step of using the hydrogen to fuel an internal combustion engine, a turbine, a furnace, a heating appliance, a cooking appliance, or other combustion apparatus.

12. The method of claim 1, further including the step of using the hydrogen as a balloon lift gas.

13. The method of claim 1, further comprising the steps of:
providing a means of bringing at least a portion of the conduit, or one or more components within or attached to the conduit up to operating temperature, and
wherein said means includes one or more of the following: application of electric power to said means, to portions of the conduit, or to components within, attached to, or in communication with the conduit, or combustion of a starting mixture and then flowing the combusted starting mixture over surfaces of, within, or attached to the conduit.

14. The method of claim 13, further including the step of using the combusted starting mixture to run an engine or other combustion apparatus during a starting period in which portions of the conduit, or components within, attached to, or in communication with the conduit are being heated to operating temperature by the combusted starting mixture.

15. An ammonia flame cracker, comprising:
a conduit having an inlet for receiving a premixed, ammonia-rich gaseous mixture of anhydrous ammonia and air;
a means of heating the mixture to a temperature high enough for rapid and substantially non-catalyzed decomposition of ammonia in bulk;
wherein the mixture, thus heated, undergoes a gaseous-phase avalanche, of water formation reactions and ammonia decomposition reactions; in portions of the gas not associated with the heating process, and
an outlet for expelling a mixture of gaseous products, resulting from the reactions, from the conduit, the mixture including non-combusted hydrogen gas

16. The ammonia flame cracker of claim 15, wherein the means of heating is a heating element within the conduit, and
wherein at least a portion of the heating results from a portion the gaseous mixture making contact with the heating element.

17. The ammonia flame cracker of claim 15, wherein the means of heating is a counterflow heat exchanger within the conduit; and
wherein at least a portion of the heating results from a transfer of heat from the mixture of gaseous products to the mixture of anhydrous ammonia and air.

18. The ammonia flame cracker of claim 16, wherein the heating element is constructed from one or more of the following elements: carbon, silicon, iron, cobalt, nickel, chromium, molybdenum and a platinum-group metal.

19. The ammonia flame cracker of claim 16, wherein the dimensions, geometry, and materials of the heating element are selected so as to initiate flamelets of combustion on a sufficiently wide distribution of points that the respective flamelets traverse the burning gas mixture before it travels appreciably far from the region immediately adjacent the element.

20. The ammonia flame cracker of claim 16, wherein the dimensions, geometry, and materials of the heating element are selected so as to catalyze enough ammonia combustion reactions such that the heating of the mixture is sufficient to reach a temperature high enough to precipitate the gaseous-phase avalanche of chemical reactions involving water formation and ammonia decomposition.

21. The ammonia flame cracker of claim 15, including means of choosing the ammonia/air equivalence ratio, of the incoming mixture, so as to obtain heating of the mixture, sufficient to reach a temperature high enough to precipitate the gaseous-phase avalanche of chemical reactions involving water formation and ammonia decomposition.

22. The ammonia flame cracker of claim 15, including means of choosing the ammonia/air equivalence ratio, of the incoming mixture, so as to obtain an optimal ammonia decomposition yield.

23. The ammonia flame cracker of claim 15, including means of storing the hydrogen for later use.

24. The ammonia flame cracker of claim 15, including means of using the hydrogen as a combustion promoter for an engine or other combustion apparatus.

25. The ammonia flame cracker of claim 15, including means of using the hydrogen to fuel an internal combustion engine, a turbine, a furnace, a heating appliance, a cooking appliance, or other combustion apparatus.

26. The ammonia flame cracker of claim 15, including means of using the hydrogen as a balloon lift gas.

27. The ammonia flame cracker of claim 15, further including means of:
bringing at least a portion of the conduit, or one or more components within or attached to the conduit up to operating temperature, and
wherein said means includes one or more of the following: application of electric power to said means, to portions of the conduit, or to components within, attached to, or in communication with the conduit, or combustion of a starting mixture and then flowing the combusted starting mixture over surfaces of, within, or attached to the conduit.

28. The ammonia flame cracker of claim 27, further including means of using the combusted starting mixture to run an engine or other combustion apparatus during a starting period in which portions of the conduit, or components within, attached to, or in communication with the conduit are being heated to operating temperature by the combusted starting mixture.

29. Apparatus for cracking and combusting gaseous ammonia, comprising:
a first conduit having one inlet for a fuel gas, another separate inlet for air, a burner in which the fuel gas and air are mixed and burned, and an exhaust outlet.
a second conduit having one inlet for gaseous ammonia and an outlet for a hydrogen-containing product mixture formed by the decomposition of at least some of the ammonia.
a heat exchange relationship between the first and second conduits,
wherein at least a portion of heat is transferred from the burner to the second conduit,
the burner and at least a portion of the second conduit being heated to a temperature high enough for rapid and substantially non-catalyzed decomposition of ammonia in bulk.

30. The apparatus of claim 29, wherein the fuel gas is ammonia.

31. The apparatus of claim 29, wherein the fuel gas is a portion of the hydrogen-containing product mixture.

32. The apparatus of claim 29, wherein the fuel gas is another fuel stored separately from the ammonia.

33. Apparatus in claim 29, further including means of operating a fuel cell wherein:
the hydrogen-containing product mixture is used as the fuel for the fuel cell, wherein the hydrogen-containing product mixture becomes a hydrogen-depleted gas mixture,
the hydrogen-depleted gas mixture is purged from the fuel cell and used as the fuel gas for combustion in the burner.

34. Apparatus of claim 29, further including means of using at least a portion of the hydrogen contained in the hydrogen-containing product mixture for one of the following applications: as a balloon lift gas, as an engine fuel in whole or in part, or storage for later use.
